(19) United States
(12) Patent Application Publication
(10) Pub. No.: US 2026/0009929 A1
(43) Pub. Date: Jan. 8, 2026

(54) LIGHT ABSORPTION ANISOTROPIC FILM, LAMINATE, COMPOSITE LENS, AND VIRTUAL REALITY DISPLAY APPARATUS

(71) Applicant: FUJIFILM Corporation, Tokyo (JP)

(72) Inventors: Naoya SHIBATA, Kanagawa (JP); Koji NAGAHASHI, Kanagawa (JP); Naoyoshi YAMADA, Kanagawa (JP); Ryuji SANETO, Kanagawa (JP)

(73) Assignee: FUJIFILM Corporation, Tokyo (JP)

(21) Appl. No.: 19/326,405

(22) Filed: Sep. 11, 2025

Related U.S. Application Data
(63) Continuation of application No. PCT/JP2024/009722, filed on Mar. 13, 2024.

(30) Foreign Application Priority Data
Mar. 23, 2023 (JP) 2023-046770
Jun. 28, 2023 (JP) 2023-106037

(51) Int. Cl. G02B 1/08; G02B 1/11; G02B 3/00; G02B 27/01

(52) U.S. Cl. CPC G02B 1/08; G02B 1/11; G02B 3/00; G02B 27/0172

(57) ABSTRACT

A light absorption anisotropic film in which occurrence of tint unevenness is suppressed in a case of being applied to a pancake lens-type virtual reality display apparatus; a laminate; a composite lens; and a virtual reality display apparatus. The light absorption anisotropic film contains a dichroic substance, in which the light absorption anisotropic film has a non-planar shape portion, and in a case where a direction of an absorption axis at each position of the non-planar shape portion is measured and a histogram related to the direction of the absorption axis is created, a half-width of a maximum peak having a highest frequency in the histogram is less than 4.0°.

### CROSS-REFERENCE TO RELATED APPLICATIONS

This application is a Continuation of PCT International Application No. PCT/JP2024/009722 filed on Mar. 13, 2024, which was published under PCT Article 21(2) in Japanese, and which claims priority under 35 U.S.C. § 119(a) to Japanese Patent Application No. 2023-046770 filed on Mar. 23, 2023 and Japanese Patent Application No. 2023-106037 filed on Jun. 28, 2023. The above applications are hereby expressly incorporated by reference, in their entirety, into the present application.

### BACKGROUND OF THE INVENTION

### 1. Field of the Invention

The present invention relates to a light absorption anisotropic film, a laminate, a composite lens, and a virtual reality display apparatus.

### 2. Description of the Related Art

A virtual reality display apparatus is a display device which can provide a realistic effect as if entering a virtual world by wearing a dedicated headset on a head and visually recognizing a video displayed through a lens.

In the virtual reality display apparatus, a configuration called a pancake lens has been proposed, the lens configuration including an image display device, a reflective type polarizer, a half mirror, a retardation layer, and the like, in which the entire thickness of a headset is reduced by reciprocating rays emitted from the image display device between the reflective type polarizer and the half mirror.

WO2022/075475A discloses a laminated optical film including a reflective circular polarizer, a retardation layer which converts circularly polarized light into linearly polarized light, and a linear polarizer in this order, and discloses that this laminated optical film can be applied to the pancake lens-type virtual reality display apparatus.

### SUMMARY OF THE INVENTION

As disclosed in WO2022/075475A, in a case where the laminated optical film is applied to the virtual reality display apparatus, the laminated optical film may be formed into a non-planar shape such as a curved surface shape, according to the shape of the lens or the like.

The present inventors have found that, in a case where the laminated optical film as disclosed in WO2022/075475A is formed in a curved surface shape and applied to the pancake lens-type virtual reality display apparatus, occurrence of tint unevenness is observed, and it is necessary to suppress the occurrence of the tint unevenness.

In view of the above-described circumstances, an object of the present invention is to provide a light absorption anisotropic film in which occurrence of tint unevenness is suppressed in a case of being applied to a pancake lens-type virtual reality display apparatus.

Another object of the present invention is to provide a laminate, a composite lens, and a virtual reality display apparatus.

As a result of intensive studies repeatedly conducted by the present inventors on the above-described object, it has been found that the above-described object can be achieved by the following configurations.

(1) A light absorption anisotropic film comprising:
a dichroic substance,
in which the light absorption anisotropic film has a non-planar shape portion, and
in a case where a direction of an absorption axis at each position of the non-planar shape portion is measured and a histogram related to the direction of the absorption axis is created, a half-width of a maximum peak having a highest frequency in the histogram is less than 4.0°.

(2) The light absorption anisotropic film according to (1), further comprising:
a liquid crystal compound.

(3) The light absorption anisotropic film according to (1) or (2),
in which the half-width is 2.0° or less.

(4) The light absorption anisotropic film according to any one of (1) to (3),
in which the non-planar shape portion has a curved surface shape, and
a curvature radius of the non-planar shape portion is 20 to 80 mm.

(5) The light absorption anisotropic film according to any one of (1) to (4),
in which the film thickness of the non-planar shape portion is 8.0 μm or less.

(6) A laminate comprising:
the light absorption anisotropic film according to any one of (1) to (5).

(7) The laminate according to (6),
in which the laminate includes the light absorption anisotropic film, a retardation layer, and a cholesteric liquid crystal layer in this order.

(8) The laminate according to (6),
in which the laminate includes the light absorption anisotropic film, a linear polarization-type reflective polarizer, and a retardation layer in this order.

(9) The laminate according to any one of (6) to (8), further comprising:
a surface antireflection layer.

(10) The laminate according to any one of (6) to (9),
in which the laminate includes two or more retardation layers, and
the retardation layer has a function of converting linearly polarized light into circularly polarized light.

(11) The laminate according to any one of (6) to (10),
in which the laminate does not include a pressure-sensitive adhesive layer.

(12) The laminate according to any one of (6) to (11), further comprising:
one or two pressure-sensitive adhesive layers.

(13) The laminate according to any one of (6) to (10),
in which, in a case where the laminate does not include both a pressure-sensitive adhesive layer and a support, a thickness of the laminate is 30 μm or less,
in a case where the laminate includes one of the pressure-sensitive adhesive layer or the support but does not include the other, a value obtained by subtracting a thickness of the one from the thickness of the laminate is 30 μm or less, and
in a case where the laminate includes both the pressure-sensitive adhesive layer and the support, a value obtained by subtracting a thickness of the pressure-sensitive adhesive layer and a thickness of the support from the thickness of the laminate is 30 μm or less.

(14) A composite lens comprising, in the following order:
the laminate according to any one of (6) to (13);
a lens; and
a half mirror.

(15) A virtual reality display apparatus comprising:
the laminate according to any one of (6) to (13).

According to the present invention, it is possible to provide a light absorption anisotropic film in which occurrence of tint unevenness is suppressed in a case of being applied to a pancake lens-type virtual reality display apparatus.

According to the present invention, it is possible to provide a laminate, a composite lens, and a virtual reality display apparatus.

### BRIEF DESCRIPTION OF THE DRAWINGS

FIG. 1 is a top view of an example of a light absorption anisotropic film according to the embodiment of the present invention.

FIG. 2 is a cross-sectional view taken along a line A-A in FIG. 1.

FIG. 3 is a view showing an example of a result of measuring a direction of an absorption axis of the light absorption anisotropic film shown in FIGS. 1 and 2 using a two-dimensional birefringence evaluation system.

FIG. 4 is a diagram showing an example of a histogram of the direction of the absorption axis.

FIG. 5 is a view for describing a procedure for forming a film using a forming die having a concave forming surface.

FIG. 6 is a view for describing a procedure for forming a film using a forming die having a concave forming surface.

FIG. 7 is a top view of the film used for the forming.

FIG. 8 is a view for describing a procedure for obtaining the light absorption anisotropic film according to the embodiment of the present invention using a forming die having a concave forming surface.

FIG. 9 is a top view of the film used for the forming.

FIG. 10 is a cross-sectional view showing an example of a laminate according to the embodiment of the present invention.

FIG. 11 is a cross-sectional view showing another example of the laminate according to the embodiment of the present invention.

FIG. 12 is a cross-sectional view showing an example of a composite lens according to the embodiment of the present invention.

FIG. 13 is a view showing an example of a virtual reality display apparatus according to the embodiment of the present invention, and shows an example of a ray of a main image.

### DESCRIPTION OF THE PREFERRED EMBODIMENTS

Hereinafter, the present invention will be described in detail.

The description of the configuration requirements described below may be made based on representative embodiments and specific examples, but the present invention is not limited to such embodiments.

Any numerical range expressed using “to” in the present specification refers to a range including the numerical values before and after the “to” as a lower limit value and an upper limit value, respectively.

In the present specification, a term “absorption axis” denotes a polarization direction in which absorbance is maximized in a plane in a case where linearly polarized light is incident. In addition, a term “reflection axis” denotes a polarization direction in which reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which refractive index is maximized in a plane.

In addition, in the present specification, Re(λ) and Rth(λ) respectively represent an in-plane direction retardation at a wavelength k and a thickness-direction retardation at a wavelength k. Unless otherwise specified, the wavelength, is 550 nm.

In the present invention, Re(λ) and Rth(λ) are values measured at the wavelength of λ in AxoScan (manufactured by Axometrics, Inc.). By inputting an average refractive index ((nx+ny+nz)/3) and a film thickness (d) in AxoScan, a slow axis direction (°), Re(λ)=R0(λ), and Rth(λ)=((nx+ny)/2−nz)×d are calculated.

Although R0(λ) is described as a numerical value calculated by AxoScan, it means Re(λ).

In addition, in the present specification, the refractive indices nx, ny, and nz are measured using an Abbe refractometer (NAR-4T, manufactured by Atago Co., Ltd.) and using a sodium lamp (λ=589 nm) as a light source. In addition, in a case of measuring the wavelength dependence, it can be measured with a multi-wavelength Abbe refractometer DR-M2 (manufactured by Atago Co., Ltd.) in combination with a dichroic filter.

In addition, values in Polymer Handbook (John Wiley & Sons, Inc.) and catalogs of various optical films can be used. The values of the average refractive index of main optical films are exemplified below: cellulose acylate (1.48), cycloolefin polymer (1.52), polycarbonate (1.59), polymethylmethacrylate (1.49), and polystyrene (1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz. The positive A-plate has an Rth showing a positive value and the negative A-plate has an Rth showing a negative value.

$$nx > ny \approx nz \qquad Expression ( A 1 )$$

$$ny > nx \approx nz \qquad Expression ( A 2 )$$

The symbol “≈” encompasses not only a case where both sides are completely the same as each other but also a case where the both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of Expression (C1) and the negative C-plate satisfies a relationship of Expression (C2). The positive C-plate has an Rth showing a negative value and the negative C-plate has an Rth showing a positive value.

$$nz > nx \approx ny \qquad Expression ( C 1 )$$

$$nz > nx \approx ny \qquad Expression ( C 2 )$$

The symbol “≈” encompasses not only a case where both sides are completely the same as each other but also a case where the both sides are substantially the same as each other. The expression “substantially the same” means that, for example, a case where (nx−ny)×d (in which d is a thickness of a film) is 0 to 10 nm and preferably 0 to 5 nm is also included in “nx≈ny”.

A feature point of the light absorption anisotropic film according to the embodiment of the present invention is that variation of a direction of an absorption axis in a non-planar shape portion is small.

The present inventors have studied the cause of the occurrence of tint unevenness in a case where the laminated optical film disclosed in WO2022/075475A is formed in a curved surface shape and applied to a pancake lens-type virtual reality display apparatus, and have found that the tint unevenness occurs due to variation of a direction of an absorption axis in a linear polarizer formed in a curved surface shape. More specifically, it is found that, in a case where the linear polarizer is formed into a curved shape, there is a portion where the orientation of the absorption axis is likely to be shifted before forming and during forming, and therefore, a so-called variation of the direction of the absorption axis occurs in the formed article in which the direction of the absorption axis is different at each position, and thus the tint unevenness occurs due to the variation. Based on the above findings, the present inventors have found that the above-described object can be achieved by using a light absorption anisotropic film in which the variation of a direction of an absorption axis in the non-planar shape portion (for example, a curved surface shape portion) is small.

The light absorption anisotropic film according to the embodiment of the present invention is a film having absorption anisotropy, and the light absorption anisotropic film has absorption anisotropy in an in-plane direction. That is, the light absorption anisotropic film has an absorption axis. The light absorption anisotropic film preferably functions as an absorptive linear polarizer.

The light absorption anisotropic film according to the embodiment of the present invention has a non-planar shape portion. In the light absorption anisotropic film, the entire film may be the non-planar shape portion, or a part of the film may be the non-planar shape portion. In a case where a part of the light absorption anisotropic film is the non-planar shape portion, the other part may be a planar shape portion.

The non-planar shape portion means a portion having a non-planar shape.

The non-planar shape means a shape other than a planar shape, and examples thereof include a curved surface shape. That is, the non-planar shape portion may be a curved surface shape portion.

The above-described curved surface shape means a shape having a curvature of more than 0, and includes a curved surface shape which is a developable surface and a three-dimensional curved surface shape. The developable surface is a surface which is developable onto a plane without stretching or contracting any part of the surface.

Examples of the curved surface shape which is a developable surface include surfaces corresponding to a cylindrical peripheral surface, an elliptical cylindrical peripheral surface, a conical peripheral surface, an elliptical conical peripheral surface, and the like; and the curved surface shape may be a convex curved surface or a concave curved surface. The three-dimensional curved surface shape is a curved surface which cannot be produced by deformation of a plane, that is, a curved surface which is not developable, and examples thereof include surfaces corresponding to a spherical surface, a rotational ellipsoid surface, and surfaces where the cross-section forms a parabola or hyperbola (for example, a rotational parabolic surface). The three-dimensional curved surface shape may be a convex curved surface or a concave curved surface.

The curved surface shape is preferably lens-like. Examples of the lens-like curved surface shape include a spherical surface shape and revolution body shapes such as a rotational ellipsoid surface shape; and the lens-like curved surface shape may be a convex lens-like shape or a concave lens-like shape.

A shape of the non-planar shape portion of the light absorption anisotropic film is preferably a spherical shape, a rotational ellipsoid shape, or a rotational parabolic surface shape. That is, it is preferable that the non-planar shape portion is a curved surface shape portion, and the curved surface shape portion is a spherical shape portion, a rotational ellipsoid shape portion, or a rotational parabolic surface shape portion.

As described above, the shape of the non-planar shape portion of the light absorption anisotropic film is preferably a revolution body shape.

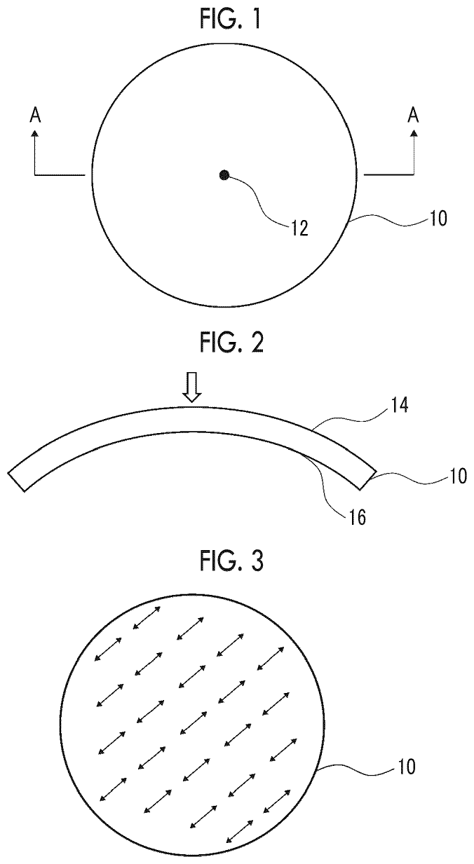

FIG. 1 shows an example of the light absorption anisotropic film according to the embodiment of the present invention.

FIG. 1 is a top view of the light absorption anisotropic film, and FIG. 2 is a cross-sectional view taken along a line A-A of FIG. 1. The line A-A is a line passing through a center 12 of a light absorption anisotropic film 10 which is circular in a plan view.

As shown in FIGS. 1 and 2, the light absorption anisotropic film 10 has a curved surface shape. More specifically, as shown in FIG. 2, the light absorption anisotropic film 10 has a shape (convex shape) which is convexly curved toward the upper side of the paper plane. That is, the light absorption anisotropic film 10 has a convex shape protruding to one surface side. It can be said that the light absorption anisotropic film 10 has a concave shape in which the other surface side is concave.

In the light absorption anisotropic film 10, the entire light absorption anisotropic film 10 corresponds to the non-planar shape portion.

As shown in FIG. 2, the light absorption anisotropic film 10 has a first surface 14 and a second surface 16 facing each other, in which the first surface 14 is a convex curved surface toward the upper side of the paper plane, and the second surface 16 is a convex curved surface toward the upper side of the paper plane.

The curved surface shape of the light absorption anisotropic film 10 shown in FIGS. 1 and 2 is a rotational parabolic surface shape, but may be a spherical shape or a rotational ellipsoid shape.

As shown in FIG. 1, in a case where the light absorption anisotropic film 10 is observed from a normal direction of a tangent plane of the center 12 (corresponding to an apex of a convex portion) of the light absorption anisotropic film 10 (in a case where the light absorption anisotropic film 10 is viewed in a plan view), the shape of the light absorption anisotropic film 10 is circular.

The center 12 of the light absorption anisotropic film 10 is an intersection between an axis of a rotational ellipsoid shape and the light absorption anisotropic film 10, and corresponds to a position where the axis of the rotational ellipsoid shape intersects with a normal line of an emission surface of n image display panel in a case where the light absorption anisotropic film 10 is incorporated into a virtual reality display apparatus described later.

In a case where the light absorption anisotropic film 10 is incorporated into a virtual reality display apparatus described later, the light absorption anisotropic film 10 is disposed to be convex toward the image display panel side.

In a cross section of the light absorption anisotropic film 10 on a plane including a normal line of a tangent plane of the center 12 of the light absorption anisotropic film 10, an outer contour line of the light absorption anisotropic film 10 (contour line corresponding to the first surface 14 of the light absorption anisotropic film 10) is a parabola.

In addition, even in a case where the light absorption anisotropic film 10 is cut on any plane parallel to the tangent plane of the center 12 of the light absorption anisotropic film 10, an outer contour line of the light absorption anisotropic film 10 (contour line corresponding to the first surface 14 of the light absorption anisotropic film 10) is circular.

In addition, in a direction (direction of a white arrow in FIG. 2) in which the normal line of the tangent plane of the center 12 of the light absorption anisotropic film 10 extends from the first surface 14 toward the second surface 16, a diameter of a circle formed by the outer contour line of the light absorption anisotropic film 10 in a case where the light absorption anisotropic film 10 is cut along a plane parallel to the tangent plane of the center 12 of the light absorption anisotropic film 10 gradually increases.

In FIG. 1, an aspect in which the shape of the non-planar shape portion of the light absorption anisotropic film is circular in a plan view has been described, but the present invention is not limited to the aspect; and the shape of the non-planar shape portion of the light absorption anisotropic film in a plan view may be an elliptical shape or another shape.

In a case where the direction of the absorption axis at each position of the non-planar shape portion in the light absorption anisotropic film according to the embodiment of the present invention is measured and a histogram (frequency histogram) related to the direction of the absorption axis obtained by the measurement is created, a half-width of a maximum peak having the highest frequency in the histogram is less than 4.0°. Among these, from the viewpoint that the occurrence of the tint unevenness is further suppressed in a case of being applied to a pancake lens-type virtual reality display apparatus (hereinafter, also simply referred to as “from viewpoint that the effect of the present invention is more excellent”), the above-described variation is preferably 2.0° or less, more preferably less than 2.0°, and still more preferably 1.0° or less. The lower limit thereof is not particularly limited, and examples thereof include more than 0°, which is 0.01° or more in many cases and 0.2° or more in more cases.

The direction of the absorption axis at each position of the non-planar shape portion in the light absorption anisotropic film can be measured using a known device, and for example, can be measured using a polarization camera.

The polarization camera is a camera which can acquire polarization information of a subject. The type of the polarization camera is not particularly limited, and examples thereof include a device in which a polarization filter including a plurality of polarizers is mounted on a sensor array (imaging element).

In addition, the above-described measurement can also be performed using a two-dimensional birefringence evaluation system.

Examples of the two-dimensional birefringence evaluation system used in the present invention include a two-dimensional birefringence evaluation system (WPA-200) manufactured by Photonic Lattice, Inc.

In a case of measuring the direction of the absorption axis, for example, light having a wavelength appropriately selected from a range of 500 to 600 nm can be used.

The direction of the absorption axis at each position of the non-planar shape portion in the light absorption anisotropic film can be calculated using a known device such as the polarization camera and the two-dimensional birefringence evaluation system described above. In the present invention, the direction of the absorption axis at at least 1,000 positions of the non-planar shape portion in the light absorption anisotropic film is measured, and a histogram described below is created.

For example, in the above-described two-dimensional birefringence evaluation system, the direction of the absorption axis at 10,000 to 200,000 positions can be obtained.

In a case where the non-planar shape portion in the light absorption anisotropic film is measured using a device such as the polarization camera and the two-dimensional birefringence evaluation system, the measurement is performed by installing the device in a direction corresponding to a normal direction of an emission surface of an image display panel, in a case where the light absorption anisotropic film is applied to a virtual reality display apparatus.

By the above-described measurement, the direction of the absorption axis at each position of the non-planar shape portion in the light absorption anisotropic film is obtained. As an example, FIG. 3 shows a result of measuring the direction of the absorption axis of the light absorption anisotropic film 10 shown in FIGS. 1 and 2 using the above-described two-dimensional birefringence evaluation system. In FIG. 3, a black arrow indicates the direction of the absorption axis at each position. In FIG. 3, in a case where the left-right direction of the paper plane is set to 0° and the counterclockwise direction is represented by a positive angle, the direction of the absorption axis at each position is 45°.

In FIG. 3, 23 black arrows are shown, and the directions of the absorption axes at 23 positions are shown, but FIG. 3 is merely a schematic diagram, and the measurement positions are as described above.

As described below, in the related art, at a position near the periphery portion of the light absorption anisotropic film 10, a deviation in the direction of the absorption axis is likely to occur before and after forming.

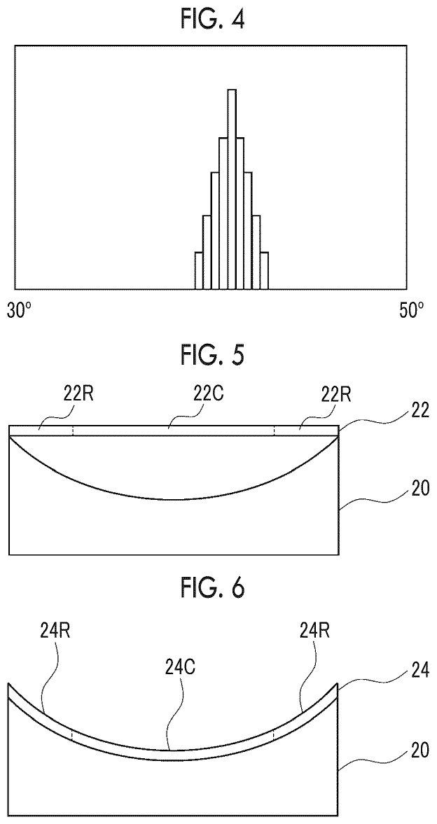

Next, a histogram related to the direction of the absorption axis is created from the above-described measurement result. FIG. 4 shows an example of the histogram related to the direction of the absorption axis. In the histogram shown in FIG. 4, a horizontal axis represents the direction (°) of the absorption axis, and a vertical axis represents a frequency (the number of positions indicating the absorption axis in a predetermined direction). In FIG. 4, one peak is observed, and this peak corresponds to the maximum peak.

The histogram is created with a class width of 0.2°. For example, as shown in FIG. 3, in a case where the average direction of the absorption axis at each position is 45°, the minimum value of the direction of the absorption axis is 40°, and the maximum value thereof is 48°, and the class width of the histogram is 0.2°, the number of bins (the number of histograms) is (48−40)/0.2=40 (histograms). The average direction of the absorption axis is a direction in which the directions of the absorption axes at the respective positions are averaged.

Next, a half-width of the maximum peak having the highest frequency in the histogram related to the direction of the obtained absorption axis is obtained.

The maximum peak means a peak having the highest frequency in the obtained histogram. In other words, the maximum peak is a peak including the class with the highest frequency. In a case where a plurality of peaks are observed in the histogram, a peak having the highest frequency among the plurality of peaks is defined as the maximum peak.

The half-width of the maximum peak is a width (°) represented by a difference between two directions (azimuthal angles) of the absorption axes, which is half of the maximum number of times of the maximum peak. In a case of calculating the above-described difference, the azimuthal angle in a certain class is a value of an arithmetic mean of the minimum value and the maximum value of each class. Specifically, as described above, since the class width of the histogram is 0.2°, in a case where the class is X° or more and less than (X°+0.2), the numerical value of X°+0.1° obtained by the expression {(X)+(X+0.2)}/2=X°+0.1° is the azimuthal angle of the class. Therefore, for example, in a case where the classes having a frequency half of the maximum frequency of the maximum peak are a class of 44.0° or more and less than 44.2° and a class of 47.4° or more and less than 47.6°, the values of respective arithmetic means thereof are 44.1° and 47.5°, and the half-width is calculated as 3.4°.

In a case where the above-described two-dimensional birefringence evaluation system (WPA-200) of Photonic Lattice, Inc. is used, the above-described histogram can be created by using an attached software (PA/WPA-View).

In a case where the non-planar shape portion of the light absorption anisotropic film has a curved surface shape (the non-planar shape portion is a curved surface shape portion), a curvature radius of the non-planar shape portion of the light absorption anisotropic film is not particularly limited, but from the viewpoint that the effect of the present invention is more excellent, it is preferably 20 to 80 mm, more preferably 30 to 80 mm, and still more preferably 35 to 60 mm.

The curvature radius of the non-planar shape portion of the light absorption anisotropic film may be constant or may vary at any position of the non-planar shape portion, and it is preferable that the curvature radius at any position is within the above-described range. In a case where the curvature radius is constant at any position of the non-planar shape portion, the shape of the non-planar shape portion corresponds to a spherical shape.

In a case where the non-planar shape portion of the light absorption anisotropic film has a curved surface shape (the non-planar shape portion is a curved surface shape portion), the minimum curvature radius of the non-planar shape portion of the light absorption anisotropic film is not particularly limited, but from the viewpoint that the effect of the present invention is more excellent, it is preferably 30 to 80 mm and more preferably 35 to 60 mm.

In a case where the non-planar shape portion of the light absorption anisotropic film has a curved surface shape (the non-planar shape portion is a curved surface shape portion), the maximum curvature radius of the non-planar shape portion of the light absorption anisotropic film is not particularly limited, but from the viewpoint that the effect of the present invention is more excellent, it is preferably 35 to 80 mm and more preferably 35 to 60 mm.

In a case where the curved surface shape of the non-planar shape portion in the light absorption anisotropic film is a spherical shape, or revolution body shapes such as a rotational ellipsoidal shape and a rotational parabolic surface shape, a size of the non-planar shape portion in a case of being seen in a plan view from a rotation axis direction of these shapes is not particularly limited, and an equivalent circle diameter of the non-planar shape portion is preferably 30 to 80 mm and more preferably 40 to 60 mm.

The equivalent circle diameter is a diameter of a virtual perfect circle assumed to have the same projected area as the projected area of the non-planar shape portion observed.

The film thickness of the non-planar shape portion in the light absorption anisotropic film is not particularly limited, but from the viewpoint that the effect of the present invention is more excellent, it is preferably 8.0 μm or less, more preferably 0.5 to 5.0 μm, and still more preferably 1.0 to 3.0 μm.

The light absorption anisotropic film contains a dichroic substance. In particular, the light absorption anisotropic film preferably contains a dichroic substance and a liquid crystal compound.

Hereinafter, materials contained in the light absorption anisotropic film will be described in detail.

### <Dichroic Substance>

The dichroic substance means a substance having different absorbances depending on directions. The dichroic substance may be immobilized in the light absorption anisotropic film.

The dichroic substance is a substance exhibiting dichroism, and the dichroism denotes a property in which an absorbance varies depending on the polarization direction.

The dichroic substance is not particularly limited, and examples thereof include a visible light absorbing material (dichroic coloring agent), a light emitting material (such as a fluorescent material or a phosphorescent material), an ultraviolet absorbing material, an infrared absorbing material, a non-linear optical material, a carbon nanotube, and an inorganic material (for example, a quantum rod). In addition, known dichroic substances (preferably, dichroic coloring agents) of the related art can be used.

As the dichroic substance, iodine or a dichroic azo coloring agent compound is preferable.

The dichroic azo coloring agent compound denotes an azo coloring agent compound having different absorbances depending on the direction. The dichroic azo coloring agent compound may or may not exhibit liquid crystallinity. In a case where the dichroic azo coloring agent compound exhibits liquid crystallinity, any of nematic properties or smectic properties may be exhibited. A temperature range at which the liquid crystal phase is exhibited is preferably room temperature (approximately 20° C. to 28° C.) to 300° C., and from the viewpoint of handleability and manufacturing suitability, more preferably 50° C. to 200° C.

In the present invention, from the viewpoint of tint adjustment, it is preferable to use at least one coloring agent compound (hereinafter, also referred to as “first dichroic azo coloring agent compound”) having a maximal absorption wavelength in a wavelength range of 560 to 700 nm and at least one coloring agent compound (hereinafter, also referred to as “second dichroic azo coloring agent compound”) having a maximal absorption wavelength in a wavelength range of 455 nm or more and less than 560 nm.

In the present invention, three or more kinds of dichroic azo coloring agent compounds may be used in combination. For example, from the viewpoint of making color of the light absorption anisotropic film close to black, it is preferable to use the first dichroic azo coloring agent compound, the second dichroic azo coloring agent compound, and at least one coloring agent compound having a maximal absorption wavelength in a wavelength range of 380 nm or more and less than 455 nm in combination.

Examples of the dichroic substance which can be used in the present invention include those described in WO2018/186503A, WO2019/189345A, and WO2018/124198A.

A content of the dichroic substance is preferably 1% to 30% by mass, more preferably 5% to 25% by mass, and still more preferably 10% to 20% by mass with respect to the total solid content mass of the light absorption anisotropic film.

### <Liquid Crystal Compound>

The light absorption anisotropic film preferably contains a liquid crystal compound.

As the liquid crystal compound, both a high-molecular-weight liquid crystal compound and a low-molecular-weight liquid crystal compound can be used, and from the viewpoint of increasing the alignment degree, a high-molecular-weight liquid crystal compound is preferable. In addition, the high-molecular-weight liquid crystal compound and the low-molecular-weight liquid crystal compound may be used in combination as the liquid crystal compound. The liquid crystal compound may be immobilized in the light absorption anisotropic film.

Here, the “high-molecular-weight liquid crystal compound” refers to a liquid crystal compound having a repeating unit in the chemical structure.

In addition, the “low-molecular-weight liquid crystal compound” refers to a liquid crystal compound having no repeating unit in the chemical structure.

The low-molecular-weight liquid crystal compound is not particularly limited, and examples thereof include a compound exhibiting a nematic liquid crystal phase and a compound exhibiting a smectic liquid crystal phase. From the viewpoint of increasing the alignment degree, a compound exhibiting a smectic liquid crystal phase is preferable. Examples thereof include liquid crystal compounds described in JP2013-228706A.

Examples of the high-molecular-weight liquid crystal compound include thermotropic liquid crystalline polymers described in JP2011-237513A.

In a case where the light absorption anisotropic film contains the high-molecular-weight liquid crystal compound, it is preferable that the high-molecular-weight liquid crystal compound forms a nematic liquid crystal phase. A temperature range at which the nematic liquid crystal phase is exhibited is preferably room temperature (23° C.) to 450° C., and more preferably 50° C. to 400° C. from the viewpoint of handleability and manufacturing suitability.

A content of the liquid crystal compound in the light absorption anisotropic film is preferably 25 to 2,000 parts by mass, more preferably 100 to 1,300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved.

The liquid crystal compound may be contained only one kind or two or more kinds. In a case of containing two or more kinds of liquid crystal compounds, the above-described content of the liquid crystal compound means the total content of the liquid crystal compounds.

It is preferable that the aligned liquid crystal compound is immobilized in the light absorption anisotropic film. Among these, in the light absorption anisotropic film, it is more preferable that the liquid crystal compound homogeneously aligned is immobilized.

It is preferable that the dichroic substance in the light absorption anisotropic film is aligned in a specific direction. Among these, in the light absorption anisotropic film, it is more preferable that the dichroic substance is aligned in one in-plane direction. In particular, it is still more preferable that the dichroic substance is also aligned in the liquid crystal compound which is homogeneously aligned.

As described later, the light absorption anisotropic film is preferably a film formed of a composition for forming a light absorption anisotropic film, which contains a liquid crystal compound and a dichroic substance.

### <Resin>

The light absorption anisotropic film may contain a resin. In particular, the light absorption anisotropic film may contain the dichroic substance and a resin.

The type of the resin is not particularly limited, but a polyvinyl alcohol-based resin (hereinafter, also referred to as “PVA-based resin”) is preferable.

In a case where the light absorption anisotropic film contains iodine and a resin, it is preferable to introduce iodine into the light absorption anisotropic film by performing a dyeing treatment with the iodine.

In addition, a single plate transmittance of the light absorption anisotropic film is preferably 40% or more, and more preferably 42% or more. The upper limit thereof is not particularly limited, but may be 60% or less.

In addition, a polarization degree of the light absorption anisotropic film is preferably 90% or more, more preferably 95% or more, and still more preferably 99% or more. The upper limit thereof is not particularly limited, but may be less than 100%.

In the light absorption anisotropic film, the single plate transmittance and the degree of polarization of the linear polarizer are measured using an automatic polarizing film measuring device: VAP-7070 (manufactured by Jasco Corporation).

<Other components>

The light absorption anisotropic film may contain an adhesion improver, a plasticizer, a polymer, and the like, in addition to the above-described components.

Here, examples of the adhesion improver include reactive additives described in paragraphs [0123] to [0129] of JP2019-91088A and boronic acid monomers described in paragraphs [0015] to [0028] of WO2015/053359A.

### <Interface Improver>

The light absorption anisotropic film according to the embodiment of the present invention may contain an interface improver.

The interface improver is not particularly limited, and a polymer-based interface improver or a low-molecular-weight interface improver can be used, or compounds described in paragraphs [0253] to [0293] of JP2011-237513A can also be used.

In addition, a silicon-based polymer can be used as the interface improver.

In addition, fluorine (meth)acrylate-based polymers described in paragraphs [0018] to [0043] of JP2007-272185A can also be used as the interface improver.

In addition, examples of the interface improver include compounds described in paragraphs [0079] to [0102] of JP2007-069471A, polymerizable liquid crystal compounds represented by Formula (4) described in JP2013-047204A (particularly, compounds described in paragraphs [0020] to [0032]), polymerizable liquid crystal compounds represented by Formula (4) described in JP2012-211306A (particularly, compounds described in paragraphs [0022] to [0029]), liquid crystal alignment promoters represented by Formula (4) described in JP2002-129162A (particularly, compounds described in paragraphs [0076] to [0078] and paragraphs [0082] to [0084]), compounds represented by Formulae (4), (II), and (III) described in JP2005-099248A (particularly, compounds described in paragraphs [0092] to [0096]), compounds described in paragraphs [0013] to [0059] of JP4385997B, compounds described in paragraphs [0018] to [0044] of JP5034200B, and compounds described in paragraphs [0019] to [0038] of JP4895088B.

The interface improvers may be used alone or in combination of two or more kinds thereof.

In a case where the light absorption anisotropic film according to the embodiment of the present invention contains an interface improver, a content of the interface improver is preferably 0.005% to 15% by mass, more preferably 0.01% to 5% by mass, and still more preferably 0.015% to 3% by mass with respect to the total mass of the light absorption anisotropic film. In a case where a plurality of interface improvers are used in combination, it is preferable that the total amount of the plurality of interface improvers is within the above-described range.

### <Method for Manufacturing Light Absorption Anisotropic Film>

A method for manufacturing the light absorption anisotropic film according to the embodiment of the present invention is not particularly limited as long as the light absorption anisotropic film having the above-described characteristics can be manufactured.

Examples thereof include a method of manufacturing a planar light absorption anisotropic film and then forming the planar light absorption anisotropic film to produce a light absorption anisotropic film having a non-planar shape portion.

Examples of the method of forming the planar light absorption anisotropic film include a method of forming the planar light absorption anisotropic film by heating the film such that a distribution of a heating temperature is provided in an in-plane direction of the film.

In the following, first, a method of producing the planar light absorption anisotropic film will be described, and then a method of forming the planar light absorption anisotropic film will be described in detail. In the following description of the forming method, a procedure for obtaining the light absorption anisotropic film 10 shown in FIGS. 1 and 2 will be described in detail as an example.

### (Method of Manufacturing Planar Light Absorption Anisotropic Film)

The method of manufacturing the planar light absorption anisotropic film is not particularly limited, and examples thereof include known methods. Among these, a method of manufacturing the planar light absorption anisotropic film using a composition for forming a light absorption anisotropic film, which contains a dichroic substance and a liquid crystal compound, is preferable.

More specific examples thereof include a method including, in the following order, a step of applying a composition for forming a light absorption anisotropic film onto a planar substrate to form a coating film (hereinafter, also referred to as “coating film forming step”) and a step of aligning a liquid crystalline component or the dichroic substance, contained in the coating film (hereinafter, also referred to as “alignment step”).

In a case where the above-described dichroic substance has liquid crystallinity, the liquid crystalline component is a component which also includes the dichroic substance having liquid crystallinity in addition to the above-described liquid crystal compound.

### —Coating Film Forming Step—

The coating film forming step is a step of applying the above-described composition for forming a light absorption anisotropic film onto a planar substrate to form a coating film.

The composition for forming a light absorption anisotropic film contains the dichroic substance and the liquid crystal compound described above. The dichroic substance and the liquid crystal compound contained in the composition for forming a light absorption anisotropic film may have a polymerizable group. As the polymerizable group, an acryloyl group, a methacryloyl group, an epoxy group, an oxetanyl group, or a styryl group is preferable; and an acryloyl group or a methacryloyl group is more preferable. In a case where the dichroic substance and the liquid crystal compound have a polymerizable group, these compounds can be immobilized in the light absorption anisotropic film in a curing step described later.

The substrate used in this step is not particularly limited, and a known planar substrate can be used.

In addition, an alignment film may be provided on the substrate as necessary. By providing the alignment film, the liquid crystalline component can be aligned. Examples of the alignment film include a photo-alignment film.

In the present step, the composition for forming a light absorption anisotropic film can be easily applied by using a composition for forming a light absorption anisotropic film, which contains a solvent, or using a liquid such as a melt obtained by heating the composition for forming a light absorption anisotropic film.

Examples of the method of applying the composition for forming a light absorption anisotropic film include known methods such as a roll coating method, a gravure printing method, a spin coating method, a wire bar coating method, an extrusion coating method, a direct gravure coating method, a reverse gravure coating method, a die-coating method, a spraying method, and an ink jet method.

### —Alignment Step—

The alignment step is a step of aligning the liquid crystalline component contained in the coating film. In this manner, the planar light absorption anisotropic film is obtained.

The alignment step may include a drying treatment. Components such as a solvent can be removed from the coating film by performing the drying treatment. The drying treatment may be performed by a method of allowing the coating film to stand at room temperature for a predetermined time (for example, natural drying) or a method of heating the coating film and/or blowing air to the coating film.

Here, the liquid crystalline component contained in the composition for forming a light absorption anisotropic film may be aligned by the coating film forming step or the drying treatment described above. For example, in an aspect in which the composition for forming a light absorption anisotropic film is prepared as a coating liquid containing a solvent, a coating film having light absorption anisotropy is obtained by drying the coating film and removing the solvent from the coating film.

In a case where the drying treatment is performed at a temperature equal to or higher than a transition temperature of the liquid crystalline component contained in the coating film from a liquid crystal phase to an isotropic phase, a heat treatment described below may not be performed.

From the viewpoint of manufacturing suitability or the like, a transition temperature of the liquid crystalline component contained in the coating film from the liquid crystal phase to the isotropic phase is preferably 10° C. to 250° C. and more preferably 25° C. to 190° C. In a case where the transition temperature is 10° C. or higher, a cooling treatment or the like for lowering the temperature to a temperature range in which the liquid crystal phase is exhibited is not necessary, which is preferable. In addition, in a case where the transition temperature is 250° C. or lower, a high temperature is not required even in a case where the coating film is heated until the phase transition to the isotropic phase is made for the purpose of suppressing alignment defects and waste of thermal energy and deformation and deterioration of the substrate can be reduced, which is preferable.

It is preferable that the alignment step includes a heat treatment. In this manner, since the liquid crystalline component contained in the coating film can be aligned, the coating film after being subjected to the heat treatment can be suitably used as the light absorption anisotropic film.

From the viewpoint of manufacturing suitability, a heating temperature is preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

### —Other Steps—

The method of forming the planar light absorption anisotropic film may include a step of curing the light absorption anisotropic film after the above-described alignment step (hereinafter, also referred to as “curing step”).

The curing step is performed by heating the light absorption anisotropic film and/or irradiating the light absorption anisotropic film with light (exposing the light absorption anisotropic film to light), for example, in a case where the compound contained in the light absorption anisotropic film has a polymerizable group. Among these, from the viewpoint of productivity, it is preferable that the curing step is performed by irradiating the light absorption anisotropic film with light.

Various light sources such as infrared rays, visible light, and ultraviolet rays can be used as a light source for the curing, but ultraviolet rays are preferable. In addition, ultraviolet rays may be applied while the light absorption anisotropic film is heated during the curing, or ultraviolet rays may be applied through a filter which transmits only a specific wavelength.

In a case where the exposure is performed while the light absorption anisotropic film is heated, the heating temperature during the exposure depends on the transition temperature of the liquid crystalline component contained in the liquid crystal film, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

In the above description, the method of using the composition for forming a light absorption anisotropic film, which contains the dichroic substance and the liquid crystal compound, has been described as the method of manufacturing the planar light absorption anisotropic film, but the present invention is not limited to this aspect.

Examples of a method of manufacturing a planar light absorption anisotropic film containing iodine and a PVA-based resin include a method of subjecting a PVA-based resin film to a dyeing treatment with the iodine and a stretching treatment (typically, uniaxial stretching).

The above-described dyeing with iodine is performed, for example, by immersing the PVA-based resin film in an iodine aqueous solution. A stretching ratio of the above-described uniaxial stretching is preferably 3 to 7 times. The stretching may be performed after the dyeing treatment or while the dyeing is performed. In addition, the stretching may be followed by the dyeing. As necessary, the PVA-based resin film is subjected to a swelling treatment, a crosslinking treatment, a washing treatment, a drying treatment, and the like. For example, by immersing the PVA-based resin film in water and washing the film with water before the dyeing, not only can the surface of the PVA-based resin film be washed to remove stains and blocking agents, but also the PVA-based resin film can be swollen to prevent dyeing unevenness and the like.

Examples of another aspect of the method of manufacturing the planar light absorption anisotropic film containing iodine and a PVA-based resin include a light absorption anisotropic film obtained by using a laminate of a resin base material and a PVA-based resin layer (PVA-based resin film) laminated on the resin base material, or a laminate of a resin base material and a PVA-based resin layer formed by coating the resin base material. The light absorption anisotropic film obtained by using the laminate of a resin base material and a PVA-based resin layer, which is formed by applying the PVA-based resin layer to the resin base material, can be produced, for example, by applying a PVA-based resin solution to the resin base material, drying the solution to form the PVA-based resin layer on the resin base material, thereby obtaining the laminate of the resin base material and the PVA-based resin layer; and stretching and dyeing the laminate to make the PVA-based resin layer as the light absorption anisotropic film. Details of the stretching, the dyeing, the swelling treatment, the crosslinking treatment, the washing treatment, and the drying treatment are the same as described above.

### (Forming Method)

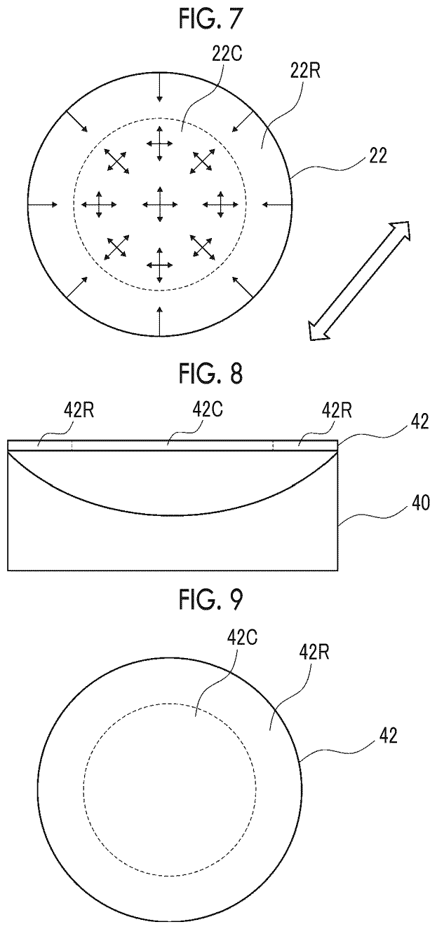

First, a phenomenon occurring in a case of forming a film using a typical forming die having a concave forming surface will be described with reference to FIGS. 5 to 7. FIGS. 5 and 6 show a procedure for forming a film using a forming die having a concave forming surface, and FIG. 7 shows the film used for the forming.

As shown in FIG. 5, a circular film 22 is placed on a forming die 20 having a concave forming surface, and as shown in FIG. 6, the film 22 is deformed along a forming surface of the forming die 20, whereby a film 24 with the concave surface shape transferred is obtained.

Usually, in a case of forming with the concave surface, a difference occurs in a direction in which a center portion 22C of the film 22 and a periphery portion 22R surrounding the center portion 22C are stretched, as shown in FIGS. 5 and 7. More specifically, as shown in FIG. 7, since the center portion 22C of the film 22 is stretched during forming in various directions as indicated by arrows, the deviation in the direction of the absorption axis is less likely to occur before and after the forming. On the other hand, since the periphery portion 22R is stretched only in a specific direction mainly indicated by an arrow depending on the position, the direction of the absorption axis is likely to be shifted before and after the forming depending on the position. For example, in FIG. 7, in a case where the absorption axis is present in a direction of a white arrow, the deviation of the direction of the absorption axis before and after the forming is likely to occur at a position farther away from the center of the film 22 in a direction orthogonal to the white arrow.

As described above, during the forming, the ease of occurrence of the deviation in the direction of the absorption axis varies depending on the position on the film to be formed. For example, as described above, in the case of concave surface forming, the deviation in the direction of the absorption axis is likely to occur at the periphery portion rather than the center portion of the obtained film.

The method of adjusting the heating conditions of the film to be formed is exemplified as a solution to the above-described problem.

Specifically, the method is a method of heating a planar light absorption anisotropic film in an in-plane direction such that a temperature distribution is provided, thereby forming the film. More specifically, examples thereof include, in the case of concave surface forming, a method of heating a planar light absorption anisotropic film such that a heating temperature of a periphery portion surrounding a center portion of the planar light absorption anisotropic film is lower than a heating temperature of the center portion, and deforming the heated planar light absorption anisotropic film along a forming surface of a forming die having a concave forming surface.

Hereinafter, the procedure will be described below with reference to the drawings, taking the case of concave surface forming as a representative example.

As described above, in a case where the forming die having a concave forming surface is used, the deviation in the direction of the absorption axis is likely to occur at the periphery portion of the film obtained by the forming rather than the center portion.

Therefore, in the above-described procedure, as shown in FIGS. 8 and 9, a heating temperature of a periphery portion 42R is set to be lower than a heating temperature of a center portion 42C of a planar light absorption anisotropic film 42 disposed on a forming die 40 having a concave forming surface, thereby making the center portion 42C easily stretched and making the periphery portion 42R difficult to be stretched in a case where the light absorption anisotropic film 42 is deformed along the forming surface. That is, as described above, in general, in the forming using the forming die having a concave forming surface, the deviation in the direction of the absorption axis occurs at the periphery portion rather than the center portion. However, by changing the heating conditions for the center portion and the periphery portion, the center portion which is less likely to be extended due to the stretching is more likely to be extended, and the periphery portion which is likely to be extended due to the stretching is less likely to be extended. As a result, in the deformed light absorption anisotropic film, the deviation in the direction of the absorption axis is suppressed.

The heating conditions for the light absorption anisotropic film are appropriately selected depending on the type of the materials of the light absorption anisotropic film to be used, the shape of the non-planar shape portion, and the forming method.

Among these, the heating temperature is preferably equal to or higher than a glass transition temperature of the light absorption anisotropic film. The upper limit of the heating temperature is not particularly limited, but is preferably a temperature within (Glass transition temperature of light absorption anisotropic film+100° C.).

In the above description, the heating of the light absorption anisotropic film itself has been described, but a laminate including the light absorption anisotropic film, which will be described later, may be heated to perform the above-described forming treatment to manufacture a laminate including a light absorption anisotropic film having a non-planar shape. In that case, in a case where the laminate includes a support, it is preferable to heat the support to a temperature equal to or higher than a glass transition temperature of the support during the heat treatment.

The heating method is not particularly limited, and examples thereof include heating by bringing the light absorption anisotropic film into contact with a heated solid, heating by bringing the light absorption anisotropic film into contact with a heated liquid, heating by bringing the light absorption anisotropic film into contact with a heated gas, heating by irradiation with infrared rays, and heating by irradiation with microwaves. Among these, heating by irradiation with infrared rays is preferable.

A wavelength of the infrared rays used for the heating is preferably 1.0 to 30.0 μm and more preferably 1.5 to 5 μm.

Examples of the infrared ray (IR) light source include a near-infrared lamp heater in which a tungsten filament is enclosed into a quartz tube, and a wavelength control heater in which a mechanism for cooling a part between quartz tubes with air is provided by multiplexing the quartz tubes. As a method of providing intensity distribution of the infrared irradiation, a method of varying the density of the arrangement of the IR light sources, or a method of placing a filter with a patterned transmittance to infrared light between the IR light sources and the planar light absorption anisotropic film can be used. As the filter in which the transmittance is patterned, a filter in which a metal is deposited on glass, a filter in which a cholesteric liquid crystal layer having a reflection band in an infrared region is provided, a filter in which a dielectric multi-layer film having a reflection band in an infrared region is provided, a filter obtained by applying an ink that absorbs infrared rays, or the like is used. The temperature of the planar light absorption anisotropic film is controlled by the intensity of the infrared irradiation, and the temperature is controlled by the infrared irradiation time and the illuminance of the infrared irradiation. The temperature of the planar light absorption anisotropic film can be monitored using a non-contact radiation thermometer, a thermocouple, or the like, and the forming can be performed at a target temperature.

In the above description, the method of heating the planar light absorption anisotropic film such that the distribution of the heating temperature is provided in the in-plane direction has been described above, but the present invention is not limited to the above-described method as long as the temperature distribution occurs in the in-plane direction of the light absorption anisotropic film during the forming. For example, a method of uniformly heating the planar light absorption anisotropic film in the in-plane direction, performing a cooling treatment such that the temperature of the periphery portion is lower than the temperature of the center portion before forming, and then performing forming to generate the temperature distribution of the planar light absorption anisotropic film in the in-plane direction may be used. The cooling treatment is not particularly limited, and examples thereof include a method of adjusting a pressurization speed in a case of pressing the film against the forming die to lower the temperature of the periphery portion, and a method of bringing only the periphery portion into contact with a refrigerant.

### <Laminate>

The laminate according to the embodiment of the present invention includes the above-described light absorption anisotropic film.

The laminate according to the embodiment of the present invention includes other members in addition to the above-described light absorption anisotropic film; and the other members are not particularly limited, and examples thereof include a retardation layer, a cholesteric liquid crystal layer, a linear polarization-type reflective polarizer, a surface antireflection layer, a pressure-sensitive adhesive layer, a support, an alignment film, and a protective layer.

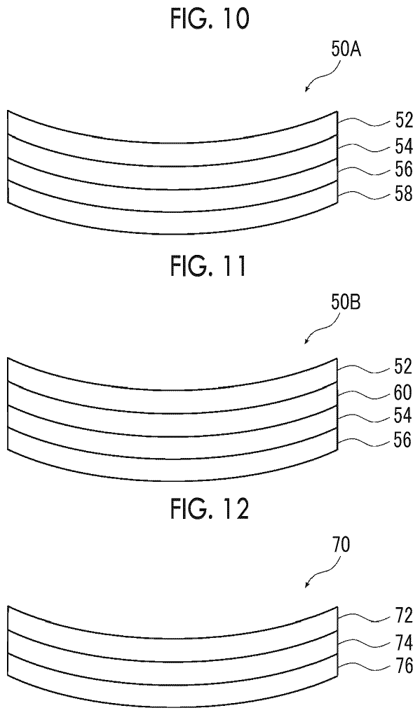

FIG. 10 shows an example of the laminate according to the embodiment of the present invention.

A laminate 50A shown in FIG. 10 includes a light absorption anisotropic film 52, a retardation layer 54 having a function of converting linearly polarized light into circularly polarized light, a positive C-plate 56, and a cholesteric liquid crystal layer 58 in this order.

FIG. 11 shows another example of the laminate according to the embodiment of the present invention.

A laminate 50B shown in FIG. 11 includes a light absorption anisotropic film 52, a linear polarization-type reflective polarizer 60, a retardation layer 54 having a function of converting linearly polarized light into circularly polarized light, and a positive C-plate 56 in this order.

As shown in FIGS. 10 and 11, any member included in the laminate 50A and the laminate 50B has the same curved surface shape as the light absorption anisotropic film 52.

In a case where the retardation layer 54 in the laminate 50A and the laminate 50B is a λ/4 plate, an angle formed by a slow axis of the retardation layer 54 and an absorption axis of the light absorption anisotropic film 52 is preferably within a range of 45°±10°. The above-described absorption axis of the light absorption anisotropic film 52 is an average direction obtained by averaging the directions of the absorption axes at the respective positions.

The laminate 50A and the laminate 50B include two retardation layers of the retardation layer 54 and the positive C-plate 56.

A retardation layer having a function of converting linearly polarized light into circularly polarized light may be further disposed on a side of the light absorption anisotropic film 52 of the laminate 50A, opposite to the retardation layer 54 side. In addition, a retardation layer having a function of converting linearly polarized light into circularly polarized light may be further disposed on a side of the light absorption anisotropic film 52 of the laminate 50B, opposite to the linear polarization-type reflective polarizer 60 side.

The laminates 50A and 50B are suitably applied to a virtual reality display apparatus described later.

The light absorption anisotropic film 52 is the above-described light absorption anisotropic film. The light absorption anisotropic film 52 is a film corresponding to the light absorption anisotropic film 10 shown in FIGS. 1 and 2.

Hereinafter, other members other than the light absorption anisotropic film, included in the laminate, will be described in detail.

(Retardation Layer Having Function of Converting Linearly Polarized Light into Circularly Polarized Light)

The retardation layer having a function of converting linearly polarized light into circularly polarized light (hereinafter, also simply referred to as “specific retardation layer”) is one kind of retardation layer.

The specific retardation layer is not particularly limited as long as it has a function of converting linearly polarized light into circularly polarized light, and examples thereof include a λ/4 plate.

The λ/4 plate is a plate having a λ/4 function, specifically, a plate having a function of converting linearly polarized light having a specific wavelength (preferably, visible light) into circularly polarized light (or converting circularly polarized light into linearly polarized light).

An in-plane retardation of the λ/4 plate at a wavelength of 550 nm is not particularly limited, but is preferably 120 to 150 nm, more preferably 125 to 145 nm, and still more preferably 135 to 140 nm.

In addition to the λ/4 plate, a retardation layer in which an in-plane retardation at a wavelength of 550 nm is ¾ or 5/4 of a wavelength of any light of visible light is also preferable.

The specific retardation layer may have reverse wavelength dispersibility. The expression “having reverse wavelength dispersibility” denotes that as the wavelength increases, the value of the phase difference at the wavelength increases.

In addition, the specific retardation layer may have a multilayer structure, and specific examples thereof include a broadband λ/4 plate obtained by laminating a λ/4 plate and a λ/2 plate.

An angle formed by a slow axis of the specific retardation layer and an absorption axis of the light absorption anisotropic film is not particularly limited, but is preferably within a range of 45°±10°.

The specific retardation layer may be a layer formed by immobilizing a liquid crystal compound twist-aligned with a thickness direction as a helical axis. For example, a retardation layer having a layer formed by immobilizing a rod-like liquid crystal compound or a disk-like liquid crystal compound twist-aligned with a thickness direction as a helical axis, as described in JP05753922B and JP05960743B, can be used.

A thickness of the specific retardation layer is not particularly limited, but is preferably 0.1 to 8 μm and more preferably 0.3 to 5 μm.

### (Positive C-Plate)

The positive C-plate is one type of retardation layer.

The positive C-plate is a retardation layer in which an in-plane retardation is substantially zero and a thickness-direction retardation has a negative value. The positive C-plate functions as an optical compensation layer for increasing the degree of polarization of the transmitted light with respect to light incident obliquely.

The in-plane retardation of the positive C-plate at a wavelength of 550 nm is preferably 10 nm or less.

The thickness-direction retardation of the positive C-plate at a wavelength of 550 nm is preferably −600 to −40 nm.

A material constituting the positive C-plate is not particularly limited, but it is preferable that the positive C-plate is formed of a composition containing a liquid crystal compound. Such a positive C-plate can be typically obtained by vertically aligning a rod-like polymerizable liquid crystal compound contained in the polymerizable liquid crystal composition and fixing the alignment state by polymerization. In addition, the positive C-plate can also be formed of a composition containing a side chain-type polymer liquid crystal compound as the liquid crystal compound.

A thickness of the positive C-plate is not particularly limited, but from the viewpoint of thinning, it is preferably 0.5 to 10 μm and more preferably 0.5 to 5 μm.

### (Cholesteric Liquid Crystal Layer)

The cholesteric liquid crystal layer is an optical member which separates incidence ray into right-circularly polarized light and left-circularly polarized light, and specularly reflects one circularly polarized light and transmits the other circularly polarized light.

Examples of the cholesteric liquid crystal layer include a cholesteric liquid crystal layer obtained by fixing a cholesteric liquid crystalline phase. From the viewpoint that a decrease in degree of polarization and a distortion of a polarization axis are suppressed in a case of being stretched or formed into a three-dimensional shape, the cholesteric liquid crystal layer is preferably used as an optical film for curved surface forming. In addition, a decrease in degree of polarization due to the distortion of the polarization axis is unlikely to occur.

It is preferable that the cholesteric liquid crystal layer includes a blue light reflecting layer in which at least reflectivity at a wavelength of 460 nm is 40% or more, a green light reflecting layer in which a reflectivity at a wavelength of 550 nm is 40% or more, a yellow light reflecting layer in which a reflectivity at a wavelength of 600 nm is 40% or more, and a red light reflecting layer in which a reflectivity at a wavelength of 650 nm is 40% or more. With such a configuration, high reflection characteristics can be exhibited over a wide wavelength range in the visible region, which is preferable. The above-described reflectivity is a reflectivity in a case where non-polarized light is incident on the cholesteric liquid crystal layer at each wavelength.

In addition, the cholesteric liquid crystal layer may have a pitch gradient structure in which a helical pitch of the cholesteric liquid crystalline phase continuously changes in the thickness direction.

In addition, it is also preferable that a cholesteric liquid crystal layer obtained by fixing a cholesteric liquid crystalline phase containing a rod-like liquid crystal compound and a cholesteric liquid crystal layer obtained by fixing a cholesteric liquid crystalline phase containing a disk-like liquid crystal compound are used in combination as the cholesteric liquid crystal layer. In such a configuration, since the cholesteric liquid crystalline phase containing a rod-like liquid crystal compound has a positive Rth and the cholesteric liquid crystalline phase containing a disk-like liquid crystal compound has a negative Rth, the Rth of each other is offset, and thus the occurrence of the tint unevenness can be suppressed even for the light incident from the oblique direction, which is preferable.

A thickness of the cholesteric liquid crystal layer is not particularly limited, but from the viewpoint of thinning, it is preferably 30 μm or less and more preferably 15 μm or less. The lower limit thereof is not particularly limited, but is 1 μm or more in many cases.

### (Linear Polarization-Type Reflective Polarizer)

The linear polarization-type reflective polarizer is a polarizer having a function of reflecting one linearly polarized light of linearly polarized light components orthogonal to each other, and allowing transmission of the other linearly polarized light components.

Examples of the linear polarization-type reflective polarizer include a film obtained by stretching a dielectric multi-layer film and a wire grid polarizer. Examples of a commercially available product include a reflective type polarizer (trade name: APF) manufactured by 3M and a wire grid polarizer (trade name: WGF) manufactured by Asahi Kasei Corporation.

An angle formed by a transmission axis of the linear polarization-type reflective polarizer and a transmission axis of the light absorption anisotropic film is preferably within a range of 0° to 10°.

### (Surface Antireflection Layer)

The laminate according to the embodiment of the present invention may include a surface antireflection layer.

In the laminate according to the embodiment of the present invention, the surface antireflection layer is preferably disposed on the outermost surface side. The surface antireflection layer may be disposed only on one surface side of the laminate, or may be disposed on both surface sides of the laminate.

The type of the surface antireflection layer is not particularly limited, but from the viewpoint of further decreasing the reflectivity, a moth-eye film or an anti reflection (AR) film is preferable. In addition, since the antireflection property can be maintained even in a case where the film thickness fluctuates due to stretching and forming, a moth-eye film is preferable.

### (Pressure-Sensitive Adhesive Layer)

The laminate according to the embodiment of the present invention may or may not include a pressure-sensitive adhesive layer. In a case where the laminate includes a pressure-sensitive adhesive layer, the number of pressure-sensitive adhesive layers is preferably one or two.

Examples of a pressure-sensitive adhesive constituting the pressure-sensitive adhesive layer include a pressure sensitive adhesive and an adhesive.

Examples of the pressure sensitive adhesive include a rubber-based pressure sensitive adhesive, an acrylic pressure sensitive adhesive, a silicone-based pressure sensitive adhesive, an urethane-based pressure sensitive adhesive, a vinyl alkyl ether-based pressure sensitive adhesive, a polyvinyl alcohol-based pressure sensitive adhesive, a polyvinylpyrrolidone-based pressure sensitive adhesive, a polyacrylamide-based pressure sensitive adhesive, and a cellulose-based pressure sensitive adhesive; and among these, an acrylic pressure sensitive adhesive (pressure-sensitive adhesive) is preferable.

Examples of the adhesive include a water-based adhesive, a solvent-based adhesive, an emulsion-based adhesive, a solvent-free adhesive, an active energy ray-curable adhesive, and a thermosetting adhesive. Examples of the active energy ray-curable adhesive include an electron beam-curable adhesive, an ultraviolet-curable adhesive, and a visible light-curable adhesive; and among these, an ultraviolet-curable adhesive is preferable.

A thickness of the pressure-sensitive adhesive layer is not particularly limited, but from the viewpoint of thinning, it is preferably 25 μm or less, more preferably 15 μm or less, and still more preferably 5 μm or less. The lower limit thereof is not particularly limited, but is 0.1 μm or more in many cases.

It is also preferable from the viewpoint of simplification and thinning to impart a function of improving the durability of the protective layer to the pressure-sensitive adhesive layer to make a configuration in which the light absorption anisotropic layer and the pressure-sensitive adhesive layer are adjacent to each other without the protective layer. For example, a configuration in which the alignment layer, the light absorption anisotropic layer, the pressure-sensitive adhesive layer, and the retardation layer are arranged adjacent to each other can be mentioned.

As the pressure-sensitive adhesive layer in this case, from the viewpoint of preventing the dichroic coloring agent in the light absorption anisotropic layer from diffusing during durability, for example, an adhesive containing polyvinyl alcohol as a main component, a UV adhesive having a low oxygen permeability, or a pressure sensitive adhesive containing a hydrophilic group-containing polymer is preferable. Among these, an adhesive containing polyvinyl alcohol as a main component is particularly preferable because it has a low oxygen permeability.

### (Support)

The laminate according to the embodiment of the present invention may include a support.

The support can be provided at any position, and for example, in a case where the cholesteric liquid crystal layer and the retardation layer are a film used by being transferred from the temporary support, the support can be used as a transfer destination thereof.

The type of the support is not particularly limited, but it is preferable that the support is transparent, and examples thereof include films made of cellulose acylate, polycarbonate, polysulfone, polyethersulfone, polyacrylate and polymethacrylate, cyclic polyolefin, polyolefin, polyamide, polystyrene, polyester, or the like. Among these, as the support, a cellulose acylate film, a cyclic polyolefin film, polyacrylate, a polyacrylate film, or a polymethacrylate film is preferable. In addition, commercially available cellulose acetate films (for example, “TD80U” or “Z-TAC” manufactured by FUJIFILM Corporation) can also be used.

In addition, it is preferable that the support has a small phase difference. Specifically, an in-plane retardation at a wavelength of 550 nm is preferably 10 nm or less, and an absolute value of the thickness-direction retardation at a wavelength of 550 nm is preferably 50 nm or less.

From the viewpoint of stretching and forming treatment, the support preferably has a tan δ peak temperature of 170° C. or lower. From the viewpoint that the forming can be performed at a low temperature, the tan δ peak temperature is preferably 150° C. or lower and more preferably 130° C. or lower.

Here, a method of measuring tan δ will be described. E″ (loss elastic modulus) and E′ (storage elastic modulus) of a film sample which has been humidity-adjusted in advance in an atmosphere of a temperature of 25° C. and a humidity of 60% Rh for 2 hours or longer are measured under the following conditions using a dynamic viscoelasticity measuring device (DVA-200, manufactured by IT Measurement & Control Co., Ltd.), and the values are used to acquire tan δ (=E″/E′).
Device: DVA-200, manufactured by IT Measurement & Control Co., Ltd.
Sample: 5 mm, length of 50 mm (gap of 20 mm)
Measurement conditions: tension mode
Measuring temperature: −150° C. to 220° C.
Temperature rising condition: 5° C./min
Frequency: 1 Hz

A thickness of the support is not particularly limited, and is preferably 5 to 300 μm, more preferably 5 to 100 μm, and still more preferably 5 to 30 μm.

### (Protective Layer)

In a case where the light absorption anisotropic film contains iodine and a PVA-based resin, a protective layer may be disposed on the light absorption anisotropic film.

Examples of a material constituting the protective layer include transparent resins including a cellulose-based resin such as triacetyl cellulose (TAC), a polyester-based resin, a polycarbonate-based resin, a polyamide-based resin, a polyimide-based resin, a polyether sulfone-based resin, a polysulfone-based resin, a polystyrene-based resin, a polynorbornene-based resin, a polyolefin-based resin, a (meth)acrylic resin, an acetate-based resin, and the like.

The protective layer is preferably optically isotropic. In the present specification, the “optically isotropic” means that an in-plane retardation at a wavelength of 550 nm is 0 to 10 nm and a thickness-direction retardation at a wavelength of 550 nm is −10 to 10 nm.

A thickness of the protective layer is not particularly limited, and is preferably 10 to 90 μm.

A thickness of the laminate is not particularly limited, but in a case where the laminate does not include the pressure-sensitive adhesive layer and the support, the thickness of the laminate is preferably 30 μm or less, and more preferably 25 μm or less. The lower limit thereof is not particularly limited, but is 10 μm or more in many cases.

In a case where the laminate includes one of the pressure-sensitive adhesive layer and the support but does not include the other, a value obtained by subtracting a thickness of the one from the thickness of the laminate is preferably 30 μm or less, and more preferably 25 μm or less. The lower limit thereof is not particularly limited, but is 10 μm or more in many cases.

In a case where the laminate includes both the pressure-sensitive adhesive layer and the support, a value obtained by subtracting a thickness of the pressure-sensitive adhesive layer and a thickness of the support from the thickness of the laminate is preferably 30 μm or less, and more preferably 25 μm or less. The lower limit thereof is not particularly limited, but is 10 μm or more in many cases.

### (Method for Manufacturing Laminate)

A method for manufacturing the laminate according to the embodiment of the present invention is not particularly limited, and examples thereof include known methods.

For example, the laminate may be manufactured by bonding other members to the surface of the light absorption anisotropic film having a non-planar shape portion, through the pressure-sensitive adhesive layer; or a laminate for forming may be manufactured by bonding other members to the surface of the planar light absorption anisotropic film through the pressure-sensitive adhesive layer, and then performing the forming method of the light absorption anisotropic film using the laminate for molding to form the laminate for forming into a predetermined shape, thereby manufacturing the laminate including the light absorption anisotropic film having a non-planar shape portion.

### <Composite Lens>

The composite lens according to the embodiment of the present invention includes the above-described laminate, a lens, and a half mirror in this order.

FIG. 12 shows an example of the composite lens according to the embodiment of the present invention.

A composite lens 70 includes a laminate 72, a lens 74, and a half mirror 76 in this order.

As shown in FIG. 12, any member included in the composite lens 70 has a curved surface shape similar to that of the light absorption anisotropic film.

The configuration of the laminate 72 is as described above.

Hereinafter, members other than the laminate, included in the composite lens, will be described in detail.

### (Lens)

The composite lens includes a lens.

Examples of the lens include a convex lens and a concave lens.

Examples of the convex lens include a biconvex lens, a plano-convex lens, and a convex meniscus lens. Examples of the concave lens include a biconcave lens, a plano-concave lens, and a concave meniscus lens.

As the lens used in the virtual reality display apparatus, a convex meniscus lens or a concave meniscus lens is preferable from the viewpoint of enlarging the angle of view, and a concave meniscus lens is more preferable from the viewpoint that chromatic aberration can be further suppressed.

As a material of the lens, a material transparent to visible light, such as glass, crystal, and plastic, can be used. Since the birefringence of the lens causes rainbow-like unevenness or light leakage, it is preferable that the birefringence is small, and a material having zero birefringence is more preferable.

### (Half Mirror)

The composite lens according to the embodiment of the present invention includes a half mirror. The half mirror is a known half mirror in the related art, which allows transmission of about half of incident light and reflects the remaining half of the incident light.

A transmittance of the half mirror is preferably 50±30% and more preferably 50±10%.

The type of the half mirror is not particularly limited, and examples thereof include a reflective layer containing a metal. Examples of the metal include silver and aluminum.

A thickness of the reflective layer is preferably 1 to 20 nm, more preferably 2 to 10 nm, and still more preferably 3 to 6 nm.

### <Virtual Reality Display Apparatus>

The virtual reality display apparatus according to the embodiment of the present invention includes the above-described light absorption anisotropic film, the above-described laminate, or the above-described composite lens.

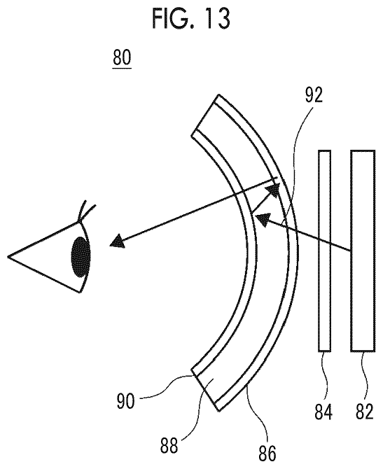

FIG. 13 is a schematic view showing an example of a configuration of the virtual reality display apparatus.

A virtual reality display apparatus 80 shown in FIG. 13 includes, from the right side in the drawing, an image display panel 82, a circularly polarizing plate 84, a half mirror 86, a lens 88, and a laminate 90 according to the embodiment of the present invention. The laminate 90 used in FIG. 13 has the same configuration as the above-described laminate 50A, and the light absorption anisotropic film 52 is disposed on the near side.

The composite lens described above is configured by the laminate 90, the lens 88, and the half mirror 86 shown in FIG. 13.

In the virtual reality display apparatus 80 shown in FIG. 13, a ray 92 emitted from an image display panel 82 is transmitted through a circularly polarizing plate 84 to be circularly polarized light, and is transmitted through a half mirror 86. Next, the ray transmits through the lens 88, is incident from the side of the cholesteric liquid crystal layer included in the laminate 90 according to the embodiment of the present invention, is reflected, transmits through the lens 88 again, is reflected by the half mirror 86 again, and is incident into the laminate 90 after being transmitted through the lens 88 again. In this case, the circular polarization state of the ray 92 does not change in a case where the ray 92 is reflected from the laminate 90, and changes to circular polarization having a turning direction opposite to that of the circular polarization incident on the laminate 90 in a case where the ray 92 is reflected from the half mirror 86. Therefore, the ray 92 is transmitted through the laminate 90, and visually recognized by a user. In addition, in a case where the ray 92 is reflected by the half mirror 86, since the half mirror has a concave mirror shape, the image is magnified so that the user can visually recognize the magnified virtual image. The system described above is referred to as a reciprocating optical system, a folded optical system, or the like.

The light absorption anisotropic film according to the embodiment of the present invention, included in the laminate 90, functions as a so-called linear polarizer, and is used to prevent light which is unnecessarily transmitted through the cholesteric liquid crystal layer from being observed by the user of the virtual reality display apparatus as tint unevenness.

In the light absorption anisotropic film according to the embodiment of the present invention, since the variation of the direction of the absorption axis at each position in the non-planar shape portion is small, the occurrence of the tint unevenness described above can be further suppressed.

The image display panel 82 is, for example, a known image display panel (display panel) such as an organic electroluminescence display panel.

In the illustrated example, the image display panel 82 emits an image (image light) of unpolarized light. The unpolarized image emitted from the image display panel 82 passes through the circularly polarizing plate 84, and is converted into circularly polarized light.

### EXAMPLES

Hereinafter, the features of the present invention will be described in more detail with reference to Examples. The materials, the used amounts, the proportions, the treatment contents, the treatment procedures, and the like described in Examples can be appropriately changed without departing from the gist of the present invention. In addition, configurations other than the configurations described below can be employed without departing from the gist of the present invention.

### <Production of Absorptive Polarizer Film 1 Including Light Absorption Anisotropic Film>

### (Production of Support)

The following composition was put into a mixing tank, stirred, and heated at 90° C. for 10 minutes. Thereafter, the obtained composition was filtered through a filter paper having an average hole diameter of 34 μm and a sintered metal filter having an average hole diameter of m to prepare a dope. The concentration of solid contents of the dope was 23.5% by mass, the amount of the plasticizer added was a proportion to cellulose acylate, and the solvent of the dope was methylene chloride/methanol/butanol=81/18/1 (mass ratio).

Cellulose acylate dope

| | |
|---|---|
| Cellulose acylate (acetyl substitution degree: | 100 parts by mass |
| 2.86, viscosity average degree of polymerization: | |
| 310) | |
| Sugar ester compound 1 (Formula (S4) shown below) | 6.0 parts by mass |
| Sugar ester compound 2 (Formula (S5) shown below) | 2.0 parts by mass |
| Silica particle dispersion (AEROSIL R972, | 0.1 parts by mass |
| manufactured by Nippon Aerosil Co., Ltd.) | |
| Solvent (methylene chloride/methanol/butanol) | 351.9 parts by mass |

(S4) 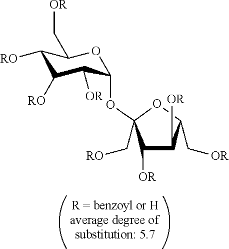
(S5)

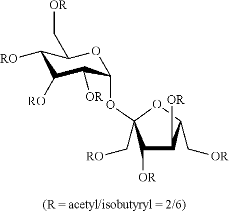

The dope produced above was cast using a drum film forming machine. The dope was cast from a die such that it was in contact with a metal support cooled to 0° C., and then the obtained web (film) was stripped from the drum. The drum was made of stainless steel (SUS).

The web (film) obtained by casting was peeled off from the drum, and then dried in a tenter device for 20 minutes at 30° C. to 40° C. during film transport, and the tenter device transported the web by clipping both ends of the web. Subsequently, the web was post-dried by zone heating while being rolled. The obtained web was subjected to knurling and then wound to obtain a cellulose acylate film A1.

In the obtained cellulose acylate film A1, a film thickness was 60 μm, an in-plane retardation Re(550) at a wavelength of 550 nm was 1 nm, and a thickness-direction retardation Rth(550) at a wavelength of 550 nm was 35 nm.

### (Formation of Photo-Alignment Film B1)

A cellulose acylate film A1 described below was continuously coated with a composition B1 for forming a photo-alignment film described below with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B1, thereby obtaining a triacetyl cellulose (TAC) film with the photo-alignment film. A film thickness of the photo-alignment film B1 was 1.5 μm.

Formulation of composition B1 for forming photo-alignment film

| | | |
|---|---|---|
| Photo-alignment compound PA-1 shown below | 100.00 | parts by mass |
| EPICLON N-695 (manufactured by DIC | 55.74 | parts by mass |
| Corporation) | | |
| jER YX7400 (manufactured by Mitsubishi | 18.75 | parts by mass |
| Chemical Corporation) | | |
| Polymerizable polymer PA-2 shown below | 8.01 | parts by mass |
| Thermal cationic polymerization initiator | 16.75 | parts by mass |
| PAG-1 shown below | | |
| Stabilizer DIPEA shown below | 1.06 | parts by mass |
| Butyl acetate | 1230.49 | parts by mass |

### Photo-Alignment Compound PA-1 (Weight-Average Molecular Weight: 32,000)

(in the formula, the numerical value described in each repeating unit denotes the content (% by mass) of each repeating unit with respect to all repeating units)

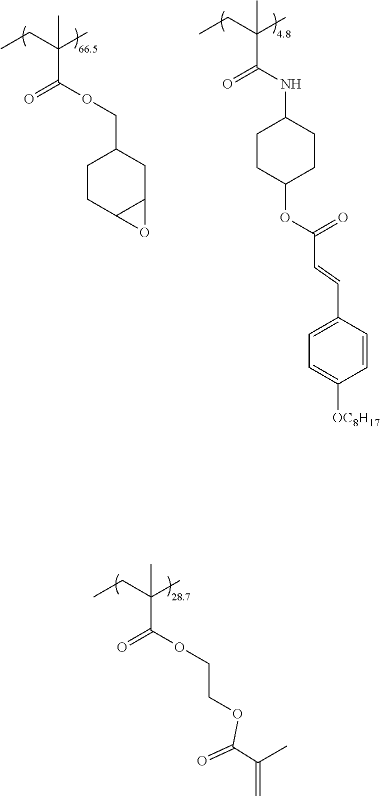

### Polymerizable Polymer PA-2 (Weight-Average Molecular Weight: 18,000)

(in the formula, numerical values of a, b, and c represent contents (% by mass) of each repeating unit with respect to all the repeating units)

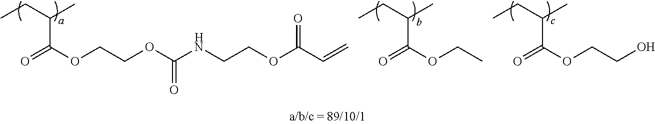

### Thermal Cationic Polymerization Initiator PAG-1

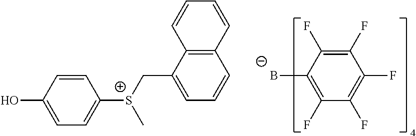

### Stabilizer DIPEA

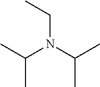

### (Formation of Light Absorption Anisotropic Film C1)

A coating film was formed by continuously coating the obtained photo-alignment film B1 with a composition C1 for forming a light absorption anisotropic film, having the following formulation, with a wire bar.

Next, the coating film was heated at 130° C. for 15 seconds, and then cooled to room temperature (23° C.). Next, the coating film was heated at 75° C. for 10 seconds, and cooled to room temperature again.

Thereafter, the coating film was irradiated with a light emitting diode (LED) lamp (central wavelength: 365 nm) under an irradiation condition of 300 mJ, thereby forming a light absorption anisotropic film (polarizer) C1 (thickness: 1.8 μm) on the photo-alignment film B1.

An absorption axis of the light absorption anisotropic film C1 was in the plane of the light absorption anisotropic film C1, and was orthogonal to a width direction of the cellulose acylate film A1.

Formulation of composition C1 for forming light absorption anistropic film

| | |
|---|---|
| Dichroic substance Dye-C1 shown below | 0.19 parts by mass |
| Dichroic substance Dye-C2 sshown below | 0.58 parts by mass |
| Dichroic substance Dye-M1 shown below | 0.19 parts by mass |
| Dichroic substance Dye-Y2 shown below | 0.03 parts by mass |
| Liquid crystal compound L-1 shown below | 3.27 parts by mass |
| Liquid crystal compound L-2 shown below | 0.70 parts by mass |
| Liquid crystal compound L-3 shown below | 0.70 parts by mass |
| Adhesion improver A-1 shown below | 0.06 parts by mass |
| Polymerization initiator IRGACURE OXE-02 (manufactured by BASF) | 0.18 parts by mass |
| Surfactant F-3 shown below | 0.009 parts by mass |
| Cyclopentanone | 91.75 parts by mass |
| Benzyl alcohol | 2.35 parts by mass |

Dichroic substance Dye-C1 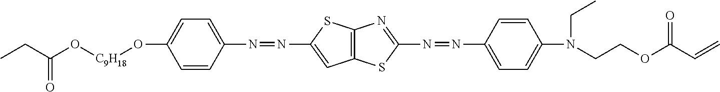
Dichroic substance Dye-C2 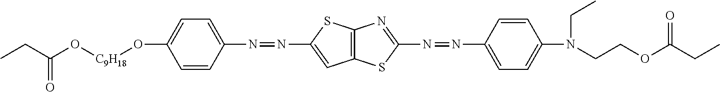
Dichroic substance Dye-M1 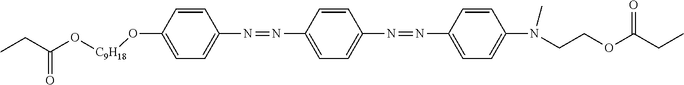
Dichroic substance Dye-Y2 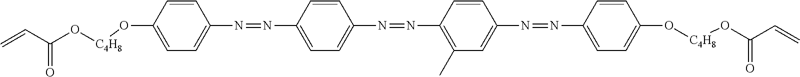
Liquid crystal compound L-1 (weight-average molecular weight: 18,000)
(in the formula, the numerical values (“59”, “15”, and “26”) described in each repeating unit denote the content (% by mass) of each repeating
unit with respect to all repeating units) 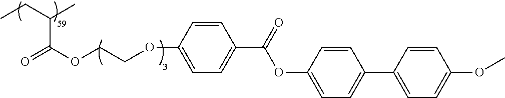 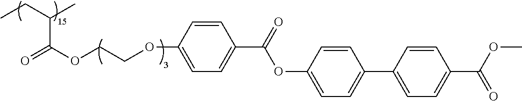 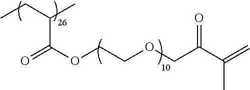
Liquid crystal compound L-2 (mixture of the following liquid crystal compounds (RA), (RB), and (RC) at a mass ratio of 84:14:2)
(RA) 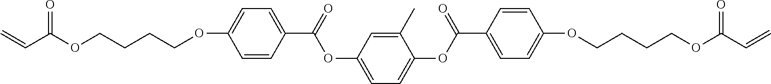 [SMILES: C=CC(=O)OCCCCOc1ccc(C(=O)Oc2ccc(OC(=O)c3ccc(OCCCCOC(=O)C=C)cc3)c(C)c2)cc1]
(RB) 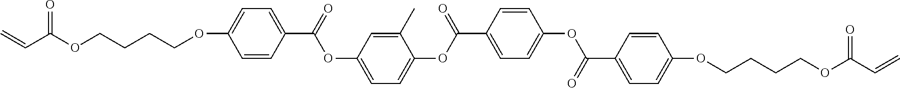 [SMILES: C=CC(=O)OCCCCOc1ccc(C(=O)Oc2ccc(C(=O)Oc3ccc(OC(=O)c4ccc(OCCCCOC(=O)C=C)cc4)cc3C)cc2)cc1]
(RC) 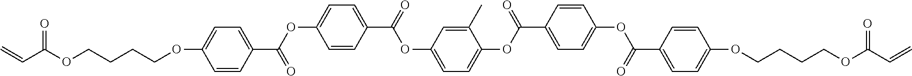 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]
Liquid crystal compound L-3 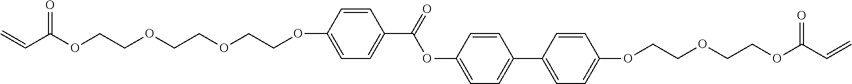 [SMILES: C=CC(=O)OCCOCCOCCOc1ccc(C(=O)Oc2ccc(-c3ccc(OCCOCCOC(=O)C=C)cc3)cc2)cc1]
Adhesion improver A-1 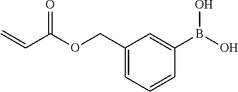
Surfactant F-3 (weight-average molecular weight: 15,000)
(in the formula, the numerical value described in each repeating unit denotes the content (% by mass) of each repeating unit with respect to all
repeating units; Ac represents —C(O)CH₃) 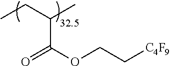 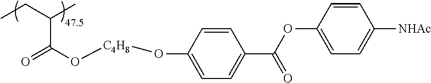 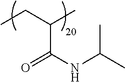
(Formation of protective layer D1)

The light absorption anisotropic film C1 was continuously coated with a coating liquid D1 for forming a protective layer, having the following formulation, with a wire bar.

Thereafter, the coating film was dried with hot air at 80° C. for 5 minutes and irradiated with light at an irradiation amount of 300 mJ using a light emitting diode (LED) lamp (central wavelength: 365 nm) to obtain a laminate with the protective layer D1 consisting of polyvinyl alcohol (PVA) and having a thickness of 0.6 μm was formed, that is, an absorptive polarizer film 1 in which the cellulose acylate film A1 (support), the photo-alignment film B1, the light absorption anisotropic film C1, and the protective layer D1 were provided adjacent to each other in this order.

Formulation of coating liquid D1 for forming protective layer

| | |
|---|---|
| Modified polyvinyl alcohol shown below | 3.31 parts by mass |
| Initiator IRGACURE 2959 (manufactured by BASF) | 0.17 parts by mass |
| Glutaraldehyde | 0.07 parts by mass |
| Pyridinium paratoluene sulfonate | 0.05 parts by mass |
| Surfactant F-9 shown below | 0.0018 parts by mass |
| Water | 74.0 parts by mass |
| Ethanol | 22.4 parts by mass |

Modified polyvinyl alcohol (weight-average molecular weight: 14,000)
(in the formula, the numerical value described in each repeating unit denotes the
content (% by mass) of each repeating unit with respect to all repeating units) 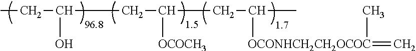
Surfactant F-9

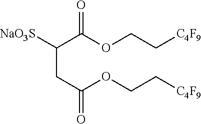

### <Production of Absorptive Polarizer Film 3 Including Light Absorption Anisotropic Film>

A cellulose acylate film A1 was produced in the same manner as in the absorptive polarizer film 1.

### (Formation of Photo-Alignment Film B2)

The above-described cellulose acylate film A1 was continuously coated with a composition B1 for forming a photo-alignment film described below with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B2, thereby obtaining a triacetyl cellulose (TAC) film with the photo-alignment film. A film thickness of the photo-alignment film B2 was 0.5 μm.

### (Formation of Light Absorption Anisotropic Film C2)

A composition C2 for forming a light absorption anisotropic film was prepared with the following formulation, dissolved by heating at 80° C. for 2 hours with stirring, and filtered through a 0.45 μm filter.

Composition C2 for forming light absorption anisotropic film

| | |
|---|---|
| Dichroic coloring agent D1 shown below | 0.8 parts by mass |
| Dichroic coloring agent D2 shown below | 2.6 parts by mass |
| Dichroic coloring agent D3 shown below | 2.2 parts by mass |
| Dichroic coloring agent D4 shown below | 1.8 parts by mass |
| Liquid crystal compound M1 shown below | 100.0 parts by mass |
| Polymerization initiator IRGACURE 369 (manufactured by BASF) | 5.0 parts by mass |
| BYK361N (manufactured by BYK Chemie Japan Co., Ltd.) | 0.9 parts by mass |
| Cyclopentanone | 925.0 parts by mass |

Dichroic coloring agent D1 (see structural formula below) 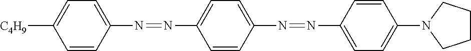
Dichroic coloring agent D2 (see structural formula below) 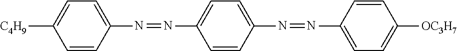
Dichroic coloring agent D3 (see structural formulae below) 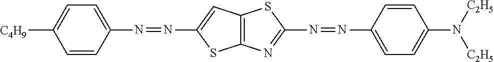
Dichroic coloring agent D4 (see structural formula below) 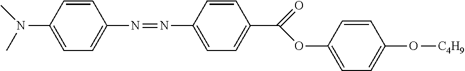
Liquid crystal compound M1 (mixing of compound A and compound B at 75/25)
(Compound A) (see structural formula below) 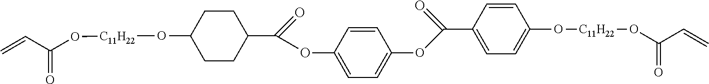
(Compound B) (see structural formula below)

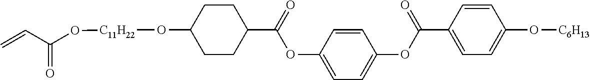

The above-described composition C2 for forming a light absorption anisotropic film was applied onto the triacetyl cellulose (TAC) film with a photo-alignment film obtained above with a wire bar. Next, the obtained coating film was heated at 120° C. for 60 seconds and cooled to room temperature.

Thereafter, the coating film was irradiated with ultraviolet rays at an exposure amount of 2,000 mJ/cm² using a high-pressure mercury lamp to form a light absorption anisotropic film C2 having a thickness of 2.5 μm.

It was confirmed that the liquid crystal of the light absorption anisotropic layer was a smectic B phase.

### (Formation of Protective Layer D1)

The light absorption anisotropic film C2 was continuously coated with the above-described coating liquid D1 for forming a protective layer with a wire bar.

Thereafter, the coating film was dried with hot air at 80° C. for 5 minutes and irradiated with light at an irradiation amount of 300 mJ using a light emitting diode (LED) lamp (central wavelength: 365 nm) to obtain a laminate with the protective layer D1 consisting of polyvinyl alcohol (PVA) and having a thickness of 0.6 μm was formed, that is, an absorptive polarizer film 3 in which the cellulose acylate film A1 (support), the photo-alignment film B2, the light absorption anisotropic film C2, and the protective layer D1 were provided adjacent to each other in this order.

### <Production of Absorptive Polarizer Film 4 Including Light Absorption Anisotropic Film>

Using, as a thermoplastic resin base material, a long and amorphous isophthalate copolymer polyethylene terephthalate film (thickness: 100 μm) having a glass transition temperature of 75° C., one surface of the resin base material was subjected to a corona treatment.

A PVA-based resin (100 parts by mass) obtained by mixing polyvinyl alcohol (degree of polymerization: 4,200, degree of saponification: 99.2 mol %) and acetylated PVA (manufactured by Nippon Synthetic Chemical Industry Co., Ltd.; trade name: “Gosefimer”) at a ratio of 9:1 was dissolved in water to prepare a PVA aqueous solution (coating liquid) by adding 13 parts by mass of potassium iodide.

The PVA aqueous solution was applied to the corona-treated surface of the resin base material, and dried at 60° C. to form a PVA-based resin layer having a thickness of 13 μm, thereby producing a laminate.

The obtained laminate was uniaxially stretched 2.4 times in the machine direction (longitudinal direction) in an oven at 130° C. (air-assisted stretching treatment).

Next, the laminate was immersed in an insolubilization bath (boric acid aqueous solution obtained by mixing 4 parts by mass of boric acid with 100 parts by mass of water) at a liquid temperature of 40° C. for 30 seconds (insolubilization treatment).

Next, the laminate was immersed in a dyeing bath (iodine aqueous solution obtained by mixing iodine and potassium iodide at a mass ratio of 1:7 with respect to 100 parts by mass of water) at a liquid temperature of 30° C. for 60 seconds while adjusting the concentration (dyeing treatment).

Next, the laminate was immersed in a crosslinking bath (boric acid aqueous solution obtained by mixing 3 parts by mass of potassium iodide and 5 parts by mass of boric acid with respect to 100 parts by mass of water) at a liquid temperature of 40° C. for 30 seconds (crosslinking treatment).

Thereafter, the laminate was uniaxially stretched in the machine direction (longitudinal direction) between rolls having different circumferential speeds such that the total stretching ratio was 5.5 times while the laminate was immersed in a boric acid aqueous solution (boric acid concentration: 4% by mass, potassium iodide concentration: 5% by mass) at a liquid temperature of 70° C. (in-water stretching treatment).

Thereafter, the laminate was immersed in a washing bath (aqueous solution obtained by mixing 3 parts by mass of potassium iodide with 100 parts by mass of water) at a liquid temperature of 20° C. (washing treatment).

Thereafter, the laminate was brought into contact with a SUS heating roll of which the surface temperature was maintained at approximately 75° C. while being dried in an oven maintained at approximately 90° C. (drying contraction treatment).

In this manner, a polarizer was formed on the resin base material, and a laminate having a configuration of resin base material/light absorption anisotropic film was obtained.

An acrylic resin film (thickness: 40 μm) was bonded to the surface of the light absorption anisotropic film of the laminate obtained above (surface opposite to the resin base material) as a visible side protective layer, with an ultraviolet curable adhesive being interposed. Specifically, the bonding was performed such that the total thickness of the curable adhesive was approximately 1.0 μm, and the sheets were bonded using a roll machine. Thereafter, the adhesive was cured by irradiating the adhesive layer with UV rays from the acrylic resin film side. Next, the resin base material was peeled off to obtain an absorptive polarizer film 4 having a configuration of acrylic resin film (viewing side protective layer)/light absorption anisotropic film.

### <Production of Retardation Layer Film 1 Including Positive A-Plate>

The above-described cellulose acylate film A1 was continuously coated with a coating liquid E1 for forming a photo-alignment film, having the following formulation, with a wire bar. The cellulose acylate film A1 on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film E1 having a thickness of 0.2 μm, thereby obtaining a TAC film with the photo-alignment film.

Coating liquid E1 for forming photo-alignment film

| | |
|---|---|
| Polymer PA-2 shown below | 100.00 parts by mass |
| Thermal cationic polymerization | 5.00 parts by mass |
| initiator PAG-1 shown above | |
| Acid generator CPI-110TF shown below | 0.005 parts by mass |
| Isopropyl alcohol | 16.50 parts by mass |
| Butyl acetate | 1072.00 parts by mass |
| Methyl ethyl ketone | 268.00 parts by mass |

Polymer PA-2 (weight-average molecular weight: 45,000)
(in the formula, the numerical value described in each repeating unit denotes
the content (% by mass) of each repeating unit with respect to all repeating units) 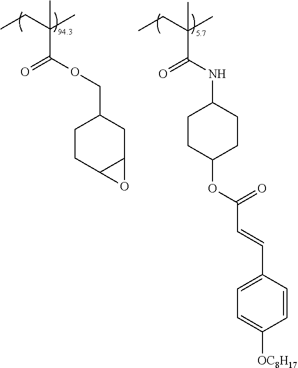
Acid generator CPI-110TF

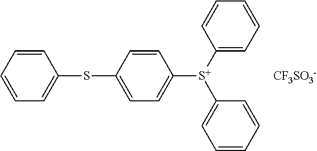

The above-described photo-alignment film E1 was coated with a composition F1 having the following formulation with a bar coater. The coating film formed on the photo-alignment film E1 was heated to 120° C. with hot air, cooled to 60° C., irradiated with ultraviolet rays having a wavelength of 365 nm with an illuminance of 100 mJ/cm² using a high-pressure mercury lamp in a nitrogen atmosphere, and continuously irradiated with ultraviolet rays with an illuminance of 500 mJ/cm² while being heated at 120° C., so that the alignment of the liquid crystal compound was immobilized, thereby producing a retardation layer 1 including a positive A-plate F1.

A thickness of the positive A-plate F1 was 2.5 μm, and an Re(550) was 144 nm. In addition, the positive A-plate satisfied a relationship of “Re(450)<Re(550)<Re(650)”. Re(450)/Re(550) was 0.82. The above-described positive A-plate corresponds to a so-called λ/4 plate.

Composition F1

| | |
|---|---|
| Polymerizable liquid crystal compound LA-1 shown below | 43.50 parts by mass |
| Polymerizable liquid crystal compound LA-2 shown below | 43.50 parts by mass |
| Polymerizable liquid crystal compound LA-3 shown below | 8.00 parts by mass |
| Polymerizable liquid crystal compound LA-4 shown below | 5.00 parts by mass |
| Polymerization initiator PI-1 shown below | 0.55 parts by mass |
| Leveling agent T-1 shown below | 0.20 parts by mass |
| Cyclopentanone | 235.00 parts by mass |

Polymerizable liquid crystal compound LA-1 (tBu represents a tertiary butyl group) 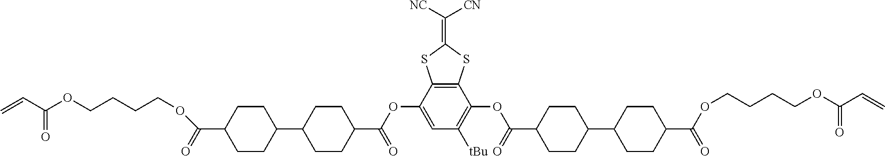 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]
Polymerizable liquid crystal compound LA-2 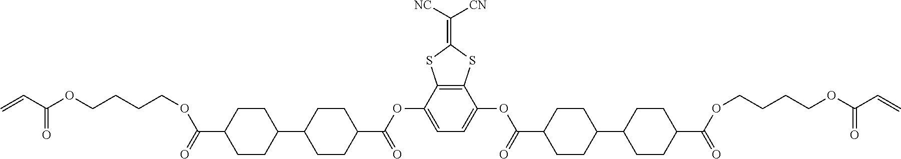 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]
Polymerizable liquid crystal compound LA-3 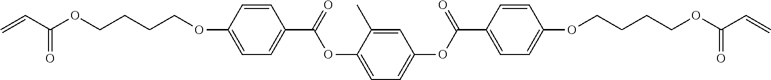 [SMILES: C=CC(=O)OCCCCOc1ccc(C(=O)Oc2ccc(OC(=O)c3ccc(OCCCCOC(=O)C=C)cc3)c(C)c2)cc1]
Polymerizable liquid crystal compound LA-4 (Me represents a methyl group) 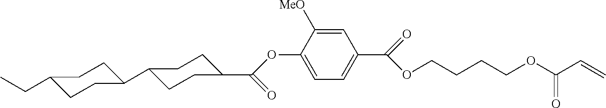 [SMILES: C=CC(=O)OCCCCOC(=O)c1ccc(OC(=O)C2CCC(C3CCC(CC)CC3)CC2)c(OC)c1]
Polymerization initiator PI-1 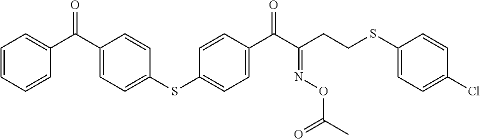 [SMILES: CC(=O)O/N=C(\CCSc1ccc(Cl)cc1)C(=O)c1ccc(Sc2ccc(C(=O)c3ccccc3)cc2)cc1]
Leveling agent T-1 (weight-average molecular weight: 25,000)
(in the formula, the numerical value described in each repeating unit denotes the content (% by mass) of each repeating unit with respect to all repeating
units)

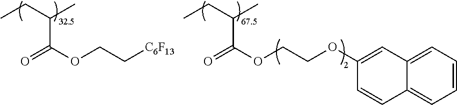

### <Production of Retardation Layer Film 2 Including Positive C-Plate>

The above-described cellulose acylate film A1 was used as a temporary support.

After passing the cellulose acylate film A1 through a dielectric heating roll at a temperature of 60° C. to raise the film surface temperature to 40° C., an alkaline solution having the formulation shown below was applied onto one surface of the film using a bar coater at a coating amount of 14 ml/m², followed by heating to 110° C., and transportation of the film under a steam type far-infrared heater manufactured by Noritake Company Limited for 10 seconds.

Next, the film was coated with pure water such that the coating amount reached 3 ml/m² using the same bar coater. Next, the film was washed with water by a fountain coater and drained by an air knife three times, and then transported to a drying zone at 70° C. for 10 seconds and dried to produce a cellulose acylate film A1 subjected to an alkali saponification treatment.

(Alkaline solution)

| | | |
|---|---|---|
| Potassium hydroxide | 4.7 | parts by mass |
| Water | 15.8 | parts by mass |
| Isopropanol | 63.7 | parts by mass |
| Fluorine-containing surfactant SF-1 | 1.0 | part by mass |
| (C₁₄H₂₉O(CH₂CH₂O)₂₀H) | | |
| Propylene glycol | 14.8 | parts by mass |

The cellulose acylate film A1 which had been subjected to the alkali saponification treatment was continuously coated with a coating liquid G1 for forming an alignment film, having the following formulation, using a #8 wire bar. The obtained film was dried with hot air at 60° C. for 60 seconds, and further dried with hot air at 100° C. for 120 seconds to form an alignment film G1.

Coating liquid G1 for forming alignment film

| | | |
|---|---|---|
| Polyvinyl alcohol (PVA103 manufactured by | 2.4 | parts by mass |
| Kuraray Co., Ltd.) | | |
| Isopropyl alcohol | 1.6 | parts by mass |
| Methanol | 36 | parts by mass |
| Water | 60 | parts by mass |

The alignment film G1 was coated with a coating liquid H1 for forming a positive C-plate, having the following formulation, the obtained coating film was aged at 60° C. for 60 seconds and irradiated with ultraviolet rays at an illuminance of 1000 mJ/cm² in the air using an air-cooled metal halide lamp at an illuminance of 70 mW/cm² (manufactured by Eye Graphics Co., Ltd.), and the alignment state thereof was fixed to vertically align the liquid crystal compound, thereby producing a retardation layer film 2 including a positive C-plate H1 with a thickness of 0.5 μm.

Rth(550) of the obtained positive C-plate was −60 nm.

Coating liquid H1 for forming positive C-plate

| | |
|---|---|
| Liquid crystal compound LC-1 shown below | 80 parts by mass |
| Liquid crystal compound LC-2 shown below | 20 parts by mass |
| Vertically aligned liquid crystal compound S01 shown below | 1 part by mass |
| Ethylene oxide-modified trimethylolpropane triacrylate (V #360, manufactured by Osaka Organic Chemical Industry Ltd.) | 8 parts by mass |
| IRGACURE 907 (manufactured by BASF SE) | 3 parts by mass |
| KAYACURE DETX (manufactured by Nippon Kayaku Co., Ltd.) | 1 part by mass |
| Compound B03 shown below | 0.4 parts by mass |
| Methyl ethyl ketone | 170 parts by mass |
| Cyclohexanone | 30 parts by mass |

Liquid crystal compound LC-1 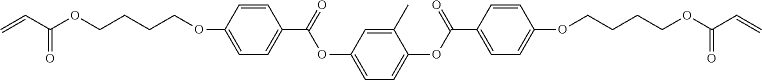 [SMILES: C=CC(=O)OCCCCOc1ccc(C(=O)Oc2ccc(OC(=O)c3ccc(OCCCCOC(=O)C=C)cc3)c(C)c2)cc1]
Liquid crystal compound LC-2 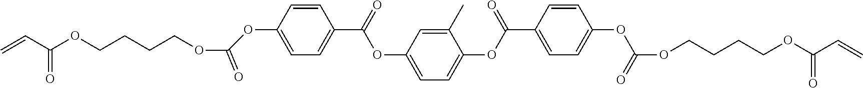 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]
Vertically aligned liquid crystal compound S01 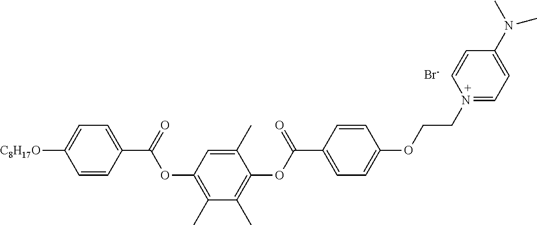
Compound B03 (weight-average molecular weight: 15,000)
(in the formula, the numerical value described in each repeating unit denotes the content (% by mass) of each repeating unit with respect to all repeating
units)

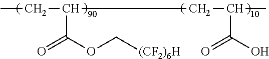

### <Production of Retardation Layer Film 3 Including Positive C-Plate/Positive A-Plate>

### (Formation of Second Optically Anisotropic Layer)

The following rod-like liquid crystal compound A (83 parts by mass), the following rod-like liquid crystal compound B (15 parts by mass), the following rod-like liquid crystal compound C (2 parts by mass), an acrylate monomer (A-400, manufactured by Shin-Nakamura Chemical Co., Ltd.) (4.2 parts by mass), the following polymer A (2 parts by mass), the following vertical alignment agent A (1.9 parts by mass), the following photopolymerization initiator A (5.1 parts by mass), the following photoacid generator A (3 parts by mass), and the following photo-alignment polymer B (0.8 parts by mass) were dissolved in methyl isobutyl ketone (567 parts by mass) to prepare a composition 1 for forming a second optically anisotropic layer.

The prepared composition 1 for forming a second optically anisotropic layer was applied onto the above-described cellulose acylate film A1 with a #3.0 wire bar, heated at 70° C. for 2 minutes, and irradiated with ultraviolet rays of 150 mJ/cm² at an oxygen concentration of less than 100 ppm. Thereafter, by performing annealing for 1 minute at 120° C., a second optically anisotropic layer was formed.

The second optically anisotropic layer was a positive C-plate satisfying the expression (C1) of nz>nx≈ny, and had a film thickness of approximately 0.5 μm.

### Rod-Like Liquid Crystal Compound A

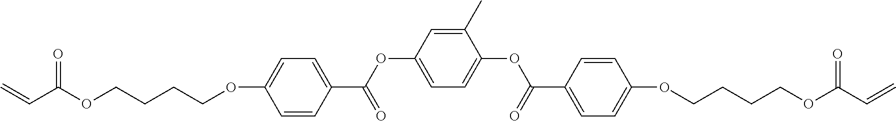 [SMILES: C=CC(=O)OCCCCOc1ccc(C(=O)Oc2ccc(OC(=O)c3ccc(OCCCCOC(=O)C=C)cc3)c(C)c2)cc1]

### Rod-Like Liquid Crystal Compound B

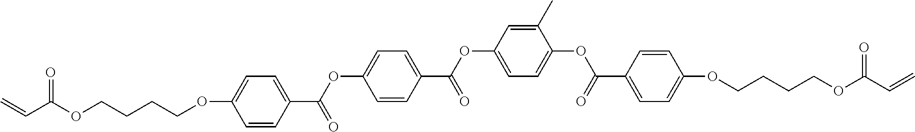 [SMILES: C=CC(=O)OCCCCOc1ccc(C(=O)Oc2ccc(C(=O)Oc3ccc(OC(=O)c4ccc(OCCCCOC(=O)C=C)cc4)c(C)c3)cc2)cc1]

### Rod-Like Liquid Crystal Compound C

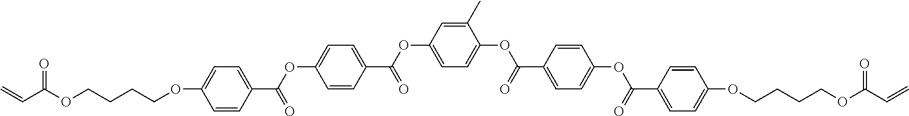 [SMILES: C=CC(=O)OCCCCOc1ccc(C(=O)Oc2ccc(C(=O)Oc3ccc(OC(=O)c4ccc(OC(=O)c5ccc(OCCCCOC(=O)C=C)cc5)cc4)c(C)c3)cc2)cc1]

### Polymer A (Weight-Average Molecular Weight: 57,000)

(in the formula, the numerical value described in each repeating unit denotes the content (% by mass) of each repeating unit with respect to all repeating units)

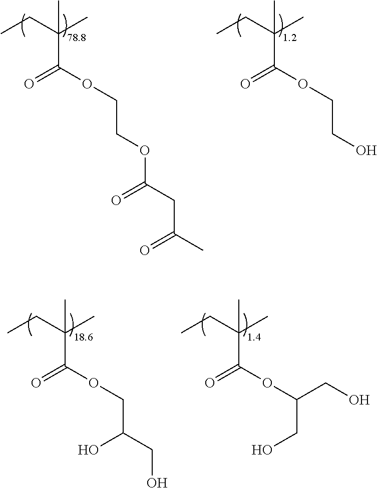

### Vertical Alignment Agent A

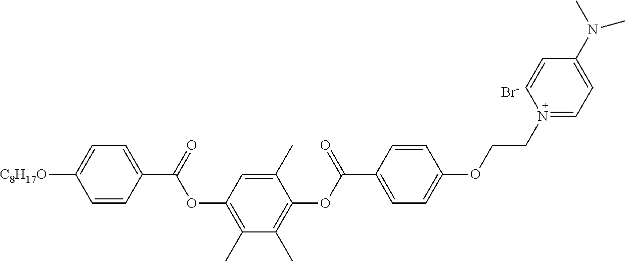

### Photopolymerization Initiator A

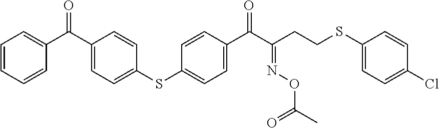 [SMILES: CC(=O)O/N=C(\CCSc1ccc(Cl)cc1)C(=O)c1ccc(Sc2ccc(C(=O)c3ccccc3)cc2)cc1]

### Photoacid Generator A

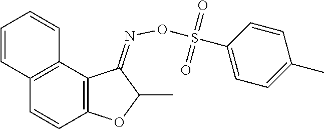 [SMILES: Cc1ccc(S(=O)(=O)O/N=C2/c3c(ccc4ccccc34)OC2C)cc1]

Photo-alignment polymer B (weight-average molecular weight: 78,000) (in the following formula, a to c are a:b:c=17:64:19, and indicate the content (% by mass) of each repeating unit with respect to all repeating units in the polymer)

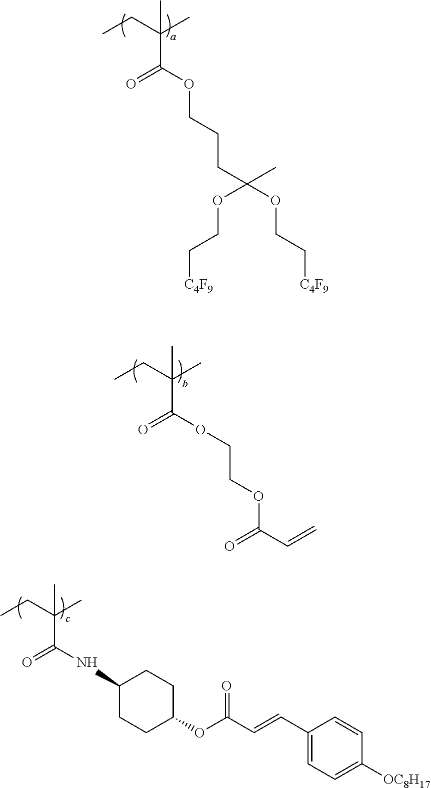

### (Irradiating Step (Impartment of Alignment Function))

The obtained second optically anisotropic layer was irradiated with ultraviolet light (UV light) (ultra-high pressure mercury lamp; UL750; manufactured by HOYA CANDEO OPTRONICS CORPORATION) passing through a wire grid type polarizer at room temperature with 7.9 mJ/cm² (wavelength: 313 nm) to impart an alignment function.

### (Formation of First Optically Anisotropic Layer (Upper Layer))

The above-described rod-like liquid crystal compound A (7.0 parts by mass), the above-described rod-like liquid crystal compound B (1.3 parts by mass), the above-described rod-like liquid crystal compound C (0.2 parts by mass), the following rod-like liquid crystal compound D (21.2 parts by mass), the following rod-like liquid crystal compound E (26.1 parts by mass), the following rod-like liquid crystal compound F (29.0 parts by mass), the following compound G (15.3 parts by mass), the following polymerizable compound M1 (5 parts by mass), the above-described photopolymerization initiator A (0.5 parts by mass), and the following polymer C (0.1 parts by mass) were dissolved in cyclopentanone (175 parts by mass), methyl ethyl ketone (50 parts by mass), and ethyl laurate (10 parts by mass) used as solvents to prepare a composition 1 for forming a first optically anisotropic layer.

The composition 1 for forming a first optically anisotropic layer was applied onto the previously formed second optically anisotropic layer with a wire bar coater #7 to form a composition layer. The formed composition layer was once heated to 120° C. on a hot plate and cooled to 60° C. so that the alignment was stabilized. Thereafter, using an ultra-high pressure mercury lamp and in a nitrogen atmosphere (oxygen concentration of less than 100 ppm), first ultraviolet irradiation (80 mJ/cm²) was carried out at a film temperature kept at 60° C., and then second ultraviolet irradiation (300 mJ/cm²) was carried out at a film temperature kept at 100° C. to fix the alignment to form a first optically anisotropic layer having a thickness of 2.8 μm, thereby producing a retardation layer film 3. The first optically anisotropic layer was a positive A-plate satisfying the expression (A1) of nx>ny≈nz, and corresponded to a so-called λ/4 plate.

### Rod-Like Liquid Crystal Compound D

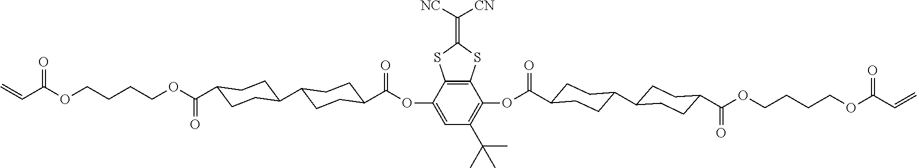 [SMILES: C=CC(=O)OCCCCOC(=O)C1CCC(C2CCC(C(=O)Oc3cc(C(C)(C)C)c(OC(=O)C4CCC(C5CCC(C(=O)OCCCCOC(=O)C=C)CC5)CC4)c4c3SC(=C(C#N)C#N)S4)CC2)CC1]

### Rod-Like Liquid Crystal Compound E

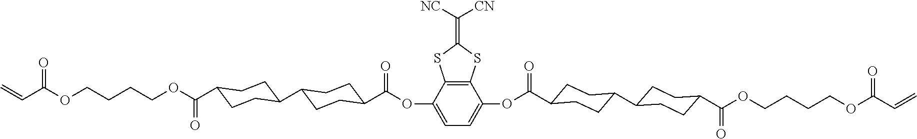 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c4c3SC(=C(C#N)C#N)S4)CC2)CC1]

### Rod-Like Liquid Crystal Compound F

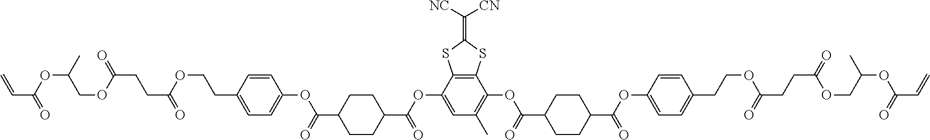 [SMILES: C=CC(=O)OC(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)OC(=O)C=C)cc5)CC4)c4c3SC(=C(C#N)C#N)S4)CC2)cc1]

### Compound G

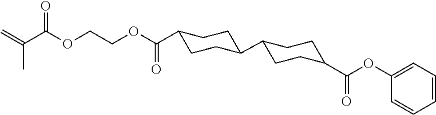 [SMILES: C=C(C)C(=O)OCCOC(=O)C1CCC(C2CCC(C(=O)Oc3ccccc3)CC2)CC1]

### Polymerizable Compound M1

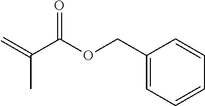

### Polymer C (Weight-Average Molecular Weight: 25,000)

(in the formula, the numerical value described in each repeating unit denotes the content (% by mass) of each repeating unit with respect to all repeating units)

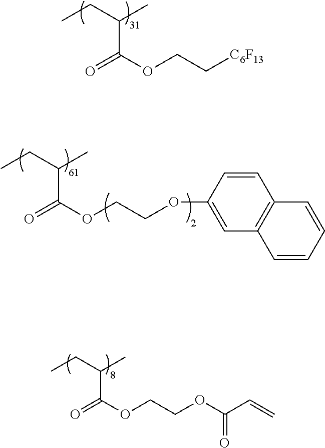

### <Production of Reflective Circular Polarizer Film 1>

### (Coating Liquid R-1 for Reflective Layer)

A composition shown below was stirred in a container held at 70° C. to prepare a coating liquid R-1 for a reflective layer. Here, R represents a coating liquid containing a rod-like liquid crystal compound.

Coating liquid R-1 for reflective layer

| | |
|---|---|
| Methyl ethyl ketone | 120.9 parts by mass |
| Cyclohexanone | 21.3 parts by mass |
| Mixture X of rod-like liquid crystal compounds shown below | 100.0 parts by mass |
| Photopolymerization initiator B shown below | 1.00 part by mass |
| Chiral agent A shown below | 4.18 parts by mass |
| Surfactant F1 shown below | 0.1 parts by mass |

Mixture X of rod-like liquid crystal compounds

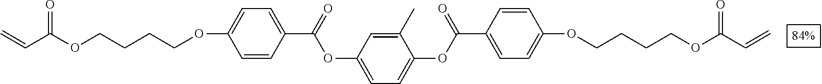 [SMILES: C=CC(=O)OCCCCOc1ccc(C(=O)Oc2ccc(OC(=O)c3ccc(OCCCCOC(=O)C=C)cc3)c(C)c2)cc1]

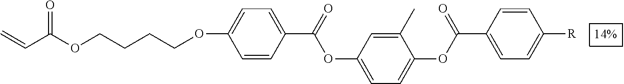

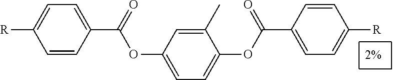

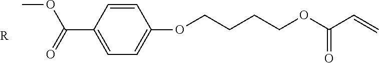

In the above-described mixture X, each numerical value denotes the content in units of % by mass. In addition, R is a group bonded through an oxygen atom. Furthermore, an average molar absorption coefficient of the above-described rod-like liquid crystal compound at a wavelength of 300 to 400 nm was 140/mol-cm.

### Photopolymerization Initiator B

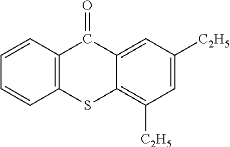 [SMILES: CCc1cc(CC)c2sc3ccccc3c(=O)c2c1]

### Chiral Agent A

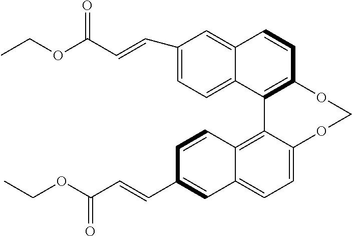

### Surfactant F1 (Weight-Average Molecular Weight: 25,000)

(the content ratio (mass ratio) between the repeating unit described on the upper side and the repeating unit described on the lower side in the formula was 76:24)

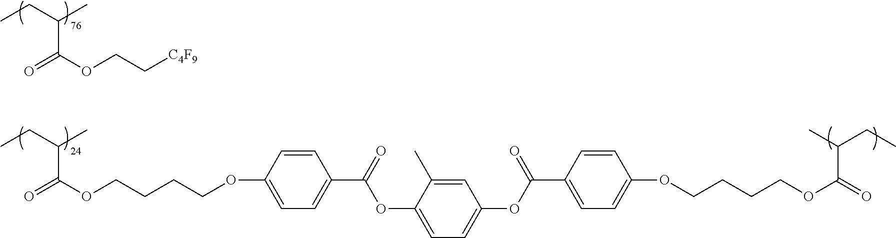

The chiral agent A was a chiral agent in which helical twisting power (HTP) was reduced by light.

### (Coating Liquid R-2 for Reflective Layer)

A coating liquid was prepared in the same manner as in the coating liquid R-1 for a reflective layer, except that the amount of the chiral agent A added was changed as shown in Table 1 below.

Table 1. Amount of chiral agent in coating liquid containing rod-like liquid crystal compound

TABLE 1

| Coating liquid name | Amount of chiral agent (part by mass) |
|---|---|
| Liquid R-1 | 4.18 |
| Liquid R-2 | 3.40 |

### (Coating Liquid D-1 for Reflective Layer)

A composition shown below was stirred in a container held at 50° C. to prepare a coating liquid D-1 for a reflective layer. Here, D represents a coating liquid containing a disk-like liquid crystal compound.

Coating liquid D-1 for reflective layer

| | |
|---|---|
| Disk-like liquid crystal compound (A) shown below | 80 parts by mass |
| Disk-like liquid crystal compound (B) shown below | 20 parts by mass |
| Polymerizable monomer E1 shown below | 10 parts by mass |
| Surfactant F2 shown below | 0.3 parts by mass |
| Photopolymerization initiator (IRGACURE 907 manufactured by BASF) | 3 parts by mass |
| Chiral agent A shown above | 5.45 parts by mass |
| Methyl ethyl ketone | 290 parts by mass |
| Cyclohexanone | 50 parts by mass |

Disk-like liquid crystal compound (A) 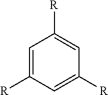 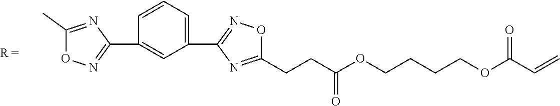 [SMILES: C=CC(=O)OCCCCOC(=O)CCc1nc(-c2cccc(-c3noc(C)n3)c2)no1]
Disk-like liquid crystal compound (B) 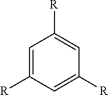 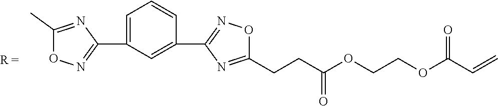 [SMILES: C=CC(=O)OCCOC(=O)CCc1nc(-c2cccc(-c3noc(C)n3)c2)no1]
Polymerizable monomer E1 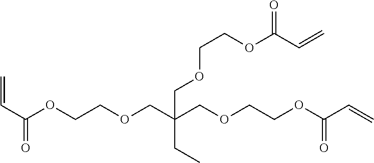 [SMILES: C=CC(=O)OCCOCC(CC)(COCCOC(=O)C=C)COCCOC(=O)C=C]
Surfactant F2

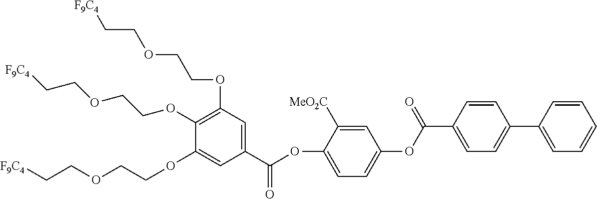

(Coating Liquids D-2 and D-3 for Reflective Layer) A coating liquid D-2 for a reflective layer was prepared in the same manner as in the coating liquid D-1 for a reflective layer, except that the amount of the chiral agent A added was changed as shown in Table 2.

Table 2. Amount of chiral agent in coating liquid containing disk-like liquid crystal compound

TABLE 2

| Coating liquid name | Amount of chiral agent (part by mass) |
|---|---|
| Liquid D-1 | 5.45 |
| Liquid D-2 | 4.52 |
| Liquid D-3 | 4.10 |

### (Coating Liquid PA-1 for Light Interference Layer)

A composition shown below was stirred in a container held at 60° C. to prepare a coating liquid PA-1 for a light interference layer.

Coating liquid PA-1 for light interference layer

| | |
|---|---|
| Methyl isobutyl ketone | 3011.0 parts by mass |
| Mixture X of rod-like liquid crystal | 100.0 parts by mass |
| compounds shown above | |
| Photopolymerization initiator C shown below | 5.1 parts by mass |
| Photoacid generator shown below | 3.0 parts by mass |
| Hydrophilic polymer shown below | 2.0 parts by mass |
| Vertical alignment agent shown below | 1.9 parts by mass |
| Viscosity reducing agent shown below | 4.2 parts by mass |
| Photo-alignment polymer B shown above | 8.0 parts by mass |
| Stabilizer shown below | 0.2 parts by mass |

Photopolymerization initiator C 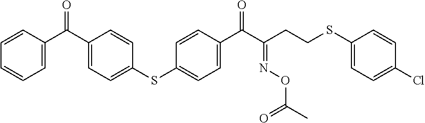 [SMILES: CC(=O)O/N=C(\CCSc1ccc(Cl)cc1)C(=O)c1ccc(Sc2ccc(C(=O)c3ccccc3)cc2)cc1]
Photoacid generator 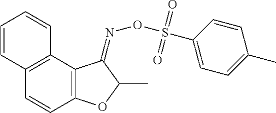 [SMILES: Cc1ccc(S(=O)(=O)O/N=C2/c3c(ccc4ccccc34)OC2C)cc1]
Hydrophilic polymer (weight-average molecular weight: 57,000)
(in the formula, the numerical value described in each repeating unit denotes
the content (% by mass) of each repeating unit with respect to all repeating
units) 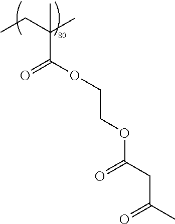 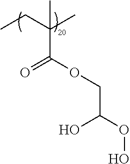
Vertical alignment agent 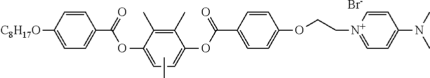
Viscosity reducing agent 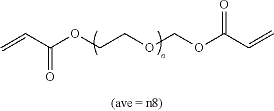
Stabilizer

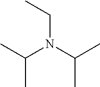

### <Production of Reflective Circular Polarizer>

As a temporary support, a triacetyl cellulose (TAC) film (manufactured by FUJIFILM Corporation, TG60) having a thickness of 60 μm was prepared.

The TAC film was coated with the coating liquid PA-1 for a light interference layer prepared above with a wire bar coater, and then dried at 80° C. for 60 seconds. Thereafter, the liquid crystal compound was cured by irradiating with light from an ultraviolet LED lamp (wavelength: 365 nm) with an irradiation amount of 300 mJ/cm² at 78° C. in a low oxygen atmosphere (100 ppm), and at the same time, a cleavage group of the photo-alignment polymer B was cleaved. Thereafter, the liquid crystal compound was heated at 115° C. for 25 seconds to eliminate a substituent containing a fluorine atom. As a result, a positive C-plate having a cinnamoyl group on the outermost surface and having a film thickness of 90 nm was formed. A refractive index nI measured with an interference film thickness meter OPTM (manufactured by Otsuka Electronics Co., Ltd., analyzed by a least squares method) was 1.57. Rth at a wavelength of 550 nm, which was measured with Axoscan (manufactured by Axometrics), was −9 nm.

Next, polarized UV light (wavelength: 313 nm) with an illuminance of 7 mW/cm² and an irradiation amount of 7.9 mJ/cm² was emitted from the positive C-plate side. The polarized UV light having a wavelength of 313 nm was obtained by transmitting ultraviolet light emitted from a mercury lamp through a band-pass filter having a transmission band at a wavelength of 313 nm and a wire grid polarizing plate. The coating liquid R-1 for a reflective layer prepared as described above was applied using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a blue light reflecting layer consisting of a cholesteric liquid crystal layer. The irradiation with light was performed from the side of the cholesteric liquid crystal layer in all cases. Here, the thickness of the coating was adjusted so that the film thickness of the cured first blue light reflecting layer was 2.6 μm.

Next, the surface of the first blue light reflecting layer was subjected to a corona treatment at a discharge amount of 150 W·min/m², and the surface subjected to the corona treatment was coated with the coating liquid D-1 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a second blue light reflecting layer on the first blue light reflecting layer. The irradiation with light was performed from the side of the cholesteric liquid crystal layer in all cases. Here, the thickness of the coating was adjusted so that the film thickness of the cured second blue light reflecting layer was 2.0 μm.

Next, the second blue light reflecting layer was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a green light reflecting layer on the second blue light reflecting layer. The irradiation with light was performed from the side of the cholesteric liquid crystal layer in all cases. Here, the coating thickness was adjusted so that the film thickness of the cured green light reflecting layer was 2.7 μm.

Next, the green light reflecting layer was coated with the coating liquid R-2 for a reflective layer using a wire bar coater, and dried at 110° C. for 72 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a red light reflecting layer on the green light reflecting layer. The irradiation with light was performed from the side of the cholesteric liquid crystal layer in all cases. Here, the coating thickness was adjusted so that the film thickness of the cured red light reflecting layer was 3.4 μm.

Next, the surface of the red light reflecting layer was subjected to a corona treatment at a discharge amount of 150 W·min/m², and the surface subjected to the corona treatment was coated with the coating liquid D-3 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a yellow light reflecting layer on the red light reflecting layer. The irradiation with light was performed from the side of the cholesteric liquid crystal layer in all cases. Here, the coating thickness was adjusted so that the film thickness of the cured yellow light reflecting layer was 3.4 μm.

Table 3 shows the reflection center wavelength and the film thickness of each of the reflective layers of the produced reflective circular polarizers. Here, the reflection center wavelength was used to define characteristics of a light reflection film having a reflection band formed of a cholesteric liquid crystal, and referred to the middle point of a spectral band reflected by the film. Specifically, the reflection center wavelength was obtained by calculating the average value of the wavelengths on the short wavelength side and the wavelengths on the long wavelength side which show the half value of the peak reflectivity. A reflection center wavelength (central wavelength of reflected light) was confirmed by producing a film obtained by applying only a single layer. The film thickness was obtained by SEM.

Table 3. Characteristics of light reflecting layer of reflective circular polarizer

TABLE 3

| | Type of | Reflection center | Film |
|---|---|---|---|
| | coating | wavelength | thickness |
| | liquid | (nm) | (μm) |
| Fifth layer | Liquid D-3 | 586 | 3.4 |
| Fourth layer | Liquid R-2 | 661 | 3.4 |
| Third layer | Liquid D-2 | 531 | 2.7 |
| Second layer | Liquid D-1 | 441 | 2.0 |
| First layer | Liquid R-1 | 475 | 2.6 |

### <Production of Moth-Eye Film 1>

With regard to the description in paragraphs [0177] to [0210] of WO2018/180003A, a substrate HC-1 with a hard coat was changed a PMMA film, and bonded with a UV adhesive. As a result, a moth-eye film 1 having a configuration of moth-eye layer/adhesive layer/PMMA film was obtained.

### <Production of Optical Laminate A0>

An optical laminate A0 was produced by the following procedure. The yellow light reflecting layer (fifth layer) side of the obtained reflective circular polarizer film 1 was bonded to a PMMA film (50 μm) with a pressure sensitive adhesive, and the temporary support (TG60) was peeled off. Furthermore, the positive C-plate side of the obtained retardation layer film 2 was bonded to the surface of the PMMA film bonded to the reflective circular polarizer film 1 with a pressure sensitive adhesive, and the support and the alignment layer were peeled off. Furthermore, the positive A-plate side of the obtained retardation layer film 1 was bonded to the exposed liquid crystal surface with a pressure sensitive adhesive, and the alignment layer and the support were peeled off. In this manner, an optical laminate A0 consisting of reflective circular polarizer/pressure sensitive adhesive layer/PMMA film/pressure sensitive adhesive layer/positive C-plate/pressure sensitive adhesive layer/positive A-plate was produced.

### <Production of Optical Laminate B0>

An optical laminate B0 was produced by the following procedure. A wideband dielectric multi-layer film (trade name: APF, 3M Company; 53 μm) was used as a linear polarization-type reflective polarizer. The liquid crystal layer side of the retardation layer film 3 was bonded to one surface of the APF with a pressure sensitive adhesive, and the support was peeled off. In this manner, an optical laminate B0 consisting of linear polarization-type reflective polarizer/pressure sensitive adhesive layer/positive A-plate/positive C-plate was produced.

### <Formation of Half Mirror>

A convex surface side of a lens (convex meniscus lens LE1076-A (diameter: 2 inches) manufactured by Thorlabs, Inc.) was subjected to aluminum vapor deposition so that the reflectivity was 40%, thereby forming a half mirror.

### Example 1

### (Production of Absorptive Polarizer Film 2K1)

The protective layer side of the absorptive polarizer film 1 was bonded to the PMMA film through a pressure sensitive adhesive sheet, only the support was peeled off to obtain an absorptive polarizer film 2, and the absorptive polarizer film 2 was set in a forming device. At this time, the PMMA film side was positioned on the upper side. The forming surface in the forming device consisted of a box 1 and a box 2 partitioned by the absorptive polarizer film 2, and a meniscus lens (diameter: 40 mm, curvature radius of concave side: 36 mm) on which aluminum was vapor-deposited on the convex side as the mold was disposed in the box 1 located below the absorptive polarizer film 2 such that the concave surface was on the upper side. In addition, a transparent window was installed on the upper portion of the box 2 above the absorptive polarizer film 2, and an IR light source for heating the absorptive polarizer film 2 was installed outside the window. Between the IR light source and the absorptive polarizer film 2, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the absorptive polarizer film 2, the absorptive polarizer film 2 was irradiated with infrared rays and heated until the center portion of the absorptive polarizer film 2 reached 108° C. and the end portion thereof reached 99° C. Since a glass transition temperature Tg of the PMMA film used as the support was 105° C., the center portion was easy to stretch and the end portion was difficult to stretch during the forming. Next, as a step of pressing the absorptive polarizer film 2 against the mold to deform the absorptive polarizer film 2 along a shape of the mold, gas was allowed to flow into the box 2 from a gas cylinder to pressurize the absorptive polarizer film 2 to 300 kPa, and the absorptive polarizer film 2 was pressed against the mold. Finally, the absorptive polarizer film 2 was removed from the lens which was the mold. In this manner, an absorptive polarizer film 2K1 formed into a curved surface was obtained.

### (Production of Optical Laminate A0K1)

The optical laminate A0 was set in a forming device. In this case, the reflective circular polarizer was disposed to be on the lower side (forming surface side). Thereafter, an optical laminate A0K1 formed into a non-planar shape was obtained in the same manner as in the method for producing the absorptive polarizer film 2K1.

### (Production of Optical Laminate A1K1)

The positive A-plate side of the optical laminate A0K1 obtained above and the photo-alignment film side of the absorptive polarizer film 2K1 were bonded to each other with a pressure sensitive adhesive. However, the positive A-plate and the light absorption anisotropic film were laminated such that a slow axis of the positive A-plate and an absorption axis (average direction of absorption axes) of the light absorption anisotropic film formed an angle of 45°. In this manner, an optical laminate A1K1 consisting of reflective circular polarizer/pressure sensitive adhesive layer/PMMA film/pressure sensitive adhesive layer/positive C-plate/pressure sensitive adhesive layer/positive A-plate/pressure sensitive adhesive layer/absorptive polarizer was produced.

### Example 2

### (Production of Absorptive Polarizer Film 2K2)

The protective layer side of the absorptive polarizer film 1 was bonded to the PMMA film through a pressure sensitive adhesive sheet, only the support was peeled off to obtain an absorptive polarizer film 2, and the absorptive polarizer film 2 was set in a forming device. At this time, the PMMA side was positioned on the upper side. The forming surface in the forming device consisted of a box 1 and a box 2 partitioned by the absorptive polarizer film 2, and a meniscus lens (diameter: 40 mm, curvature radius of concave side: 36 mm) on which aluminum was vapor-deposited on the convex side as the mold was disposed in the box 1 located below the absorptive polarizer film 2 such that the concave surface was on the upper side. In addition, a transparent window was installed on the upper portion of the box 2 above the absorptive polarizer film 2, and an IR light source for heating the absorptive polarizer film 2 was installed outside the window. Next, each of the inside of the box 1 and the inside of the box 2 was evacuated to 0.1 atm or less by a vacuum pump. Next, as a step of heating the absorptive polarizer film 2, the absorptive polarizer film 2 was irradiated with infrared rays and heated until the center portion of the absorptive polarizer film 2 reached 108° C. Next, as a step of pressing the absorptive polarizer film 2 against the mold to deform the absorptive polarizer film 2 along a shape of the mold, gas was allowed to flow into the box 2 from a gas cylinder to pressurize the absorptive polarizer film 2 to 300 kPa, and the absorptive polarizer film 2 was pressed against the mold. At this time, the pressurization speed until reaching 300 kPa was adjusted such that the temperature of the end portion in the mold immediately after the compression was set to 99° C. Since a glass transition temperature Tg of the PMMA film used as the support was 105° C., the center portion was in a state of being easily stretched during the forming, and the end portion was in a state of being difficult to stretch during the forming. Finally, the absorptive polarizer film 2 was removed from the lens which was the mold. In this manner, an absorptive polarizer film 2K2 formed into a curved surface was obtained.

### (Production of Optical Laminate A1K2)

An optical laminate A1K2 was obtained as Example 2 in the same manner as in the production of the optical laminate A1K1 of Example 1, except that the optical laminate A0K1 and the absorptive polarizer film 2K2 were bonded to each other.

### Example 3

### (Production of Absorptive Polarizer Film 2K3)

An optical laminate A1K3 was obtained as Example 3 in the same manner as in the production of the optical laminate A1K1 of Example 1, except that all the pressure sensitive adhesives used for the bonding was changed to UV adhesives.

### Example 4

### (Production of Absorptive Polarizer Film 2K1)

The protective layer side of the absorptive polarizer film 1 was bonded to the PMMA film through a pressure sensitive adhesive sheet, only the support was peeled off to obtain an absorptive polarizer film 2, and the absorptive polarizer film 2 was set in a forming device. At this time, the PMMA film side was positioned on the upper side. The forming surface in the forming device consisted of a box 1 and a box 2 partitioned by the absorptive polarizer film 2, and a meniscus lens (diameter: 50 mm, curvature radius of concave side: 52 mm) on which aluminum was vapor-deposited on the convex side as the mold was disposed in the box 1 located below the absorptive polarizer film 2 such that the concave surface was on the upper side. In addition, a transparent window was installed on the upper portion of the box 2 above the absorptive polarizer film 2, and an IR light source for heating the absorptive polarizer film 2 was installed outside the window. Between the IR light source and the absorptive polarizer film 2, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the absorptive polarizer film 2, the absorptive polarizer film 2 was irradiated with infrared rays and heated until the center portion of the absorptive polarizer film 2 reached 108° C. and the end portion thereof reached 99° C. Since a glass transition temperature Tg of the PMMA film used as the support was 105° C., the center portion was easy to stretch and the end portion was difficult to stretch during the forming. Next, as a step of pressing the absorptive polarizer film 2 against the mold to deform the absorptive polarizer film 2 along a shape of the mold, gas was allowed to flow into the box 2 from a gas cylinder to pressurize the absorptive polarizer film 2 to 300 kPa, and the absorptive polarizer film 2 was pressed against the mold. Finally, the absorptive polarizer film 2 was removed from the lens which was the mold.

In this manner, an absorptive polarizer film 2K4 formed into a curved surface was obtained.

### (Production of Optical Laminate A0K4)

The optical laminate A0 was set in a forming device. In this case, the reflective circular polarizer was disposed to be on the lower side. Thereafter, an optical laminate A0K4 formed into a non-planar shape was obtained in the same manner as in the method for producing the absorptive polarizer film 2K4.

### (Production of Optical Laminate A1K4)

An optical laminate A1K4 was obtained as Example 4 in the same manner as in the production of the optical laminate A1K1 of Example 1, except that the optical laminate A0K4 and the absorptive polarizer film 2K4 were bonded to each other.

### Example 5

### (Production of Optical Laminate A1K5)

An optical laminate A1K5 was obtained as Example 5 in the same manner as in the production of the optical laminate A1K4 of Example 4, except that the curvature radius of the mold was changed from 52 mm to 78 mm.

### Example 6

### (Production of Absorptive Polarizer Film 2K6)

An absorptive polarizer film 2K6 formed in a non-planar shape was produced in the same manner as in the production of the absorptive polarizer film 2K4 of Example 4, except that the curvature radius of the mold was changed from 52 mm to 64 mm.

### (Formation of Optical Laminate B0K6)

The optical laminate B0 was set in a forming device. In this case, the positive C-plate side was disposed to be on the lower side. The forming surface in the forming device consisted of a box 1 and a box 2 partitioned by the optical laminate B0, and a meniscus lens (diameter: 50 mm, curvature radius of concave side: 64 mm) on which aluminum was vapor-deposited on the convex side as the mold was disposed in the box 1 located below the optical laminate B0 such that the concave surface was on the upper side. In addition, a transparent window was installed on the upper part of the box 2 on the upper side of the optical laminate B0, and an IR light source for heating the optical laminate B0 was installed on the outside of the forming device. Between the IR light source and the optical laminate B0, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the optical laminate B0, the optical laminate B0 was irradiated with infrared rays and heated until the center portion of the optical laminate B0 reached 108° C. and the end portion thereof reached 99° C. Next, as a step of pressing the optical laminate B0 against the mold to deform the optical laminate B0 along a shape of the mold, gas was allowed to flow into the box 2 from a gas cylinder to pressurize the optical laminate B0 to 300 kPa, and the optical laminate B0 was pressed against the mold. Finally, the optical laminate B0 was removed from the lens which was the mold. As a result, an optical laminate B0K6 formed into a non-planar shape was obtained.

### (Production of Optical Laminate B1K6)

The APF side of the optical laminate B0K6 obtained above and the photo-alignment film side of the absorptive polarizer film 2K6 were bonded to each other with a pressure sensitive adhesive. However, the APF and the light absorption anisotropic film were laminated such that the transmission axis of the APF and the transmission axis of the light absorption anisotropic film matched each other. In this manner, an optical laminate B1K6 consisting of positive C-plate/positive A-plate/pressure sensitive adhesive layer/APF/pressure sensitive adhesive layer/absorptive polarizer was obtained as Example 6.

### Example 7

### (Production of Optical Laminate B1K7)

An optical laminate B1K7 was obtained as Example 7 in the same manner as in the production of the optical laminate B1K6 of Example 6, except that the curvature radius of the mold was changed from 64 mm to 75 mm and all the pressure sensitive adhesives used for the bonding was changed to UV adhesives.

### Comparative Example 1

### (Production of Absorptive Polarizer Film 2K21)

The protective layer side of the absorptive polarizer film 1 was bonded to the PMMA film through a pressure sensitive adhesive sheet, only the support was peeled off to obtain an absorptive polarizer film 2, and the absorptive polarizer film 2 was set in a forming device. At this time, the PMMA side was positioned on the upper side. The forming surface in the forming device consisted of a box 1 and a box 2 partitioned by the absorptive polarizer film 2, and a meniscus lens (diameter: 40 mm, curvature radius of concave side: 36 mm) on which aluminum was vapor-deposited on the convex side as the mold 2 was disposed in the box 1 located below the absorptive polarizer film 2 such that the concave surface was on the upper side. In addition, a transparent window was installed on the upper portion of the box 2 above the absorptive polarizer film 2, and an IR light source for heating the absorptive polarizer film 2 was installed outside the window. Next, each of the inside of the box 1 and the inside of the box 2 was evacuated to 0.1 atm or less by a vacuum pump. Next, as a step of heating the absorptive polarizer film 2, the absorptive polarizer film 2 was irradiated with infrared rays and heated until the temperature of the absorptive polarizer film 2 reached 108° C. Next, as a step of pressing the absorptive polarizer film 2 against the mold 2 to deform the absorptive polarizer film 2 along a shape of the mold 2, gas was allowed to flow into the box 2 from a gas cylinder to pressurize the absorptive polarizer film 2 to 300 kPa, and the absorptive polarizer film 2 was pressed against the mold 2. Next, the absorptive polarizer film 2 was removed from the lens which was the mold. In this manner, an absorptive polarizer film 2K21 formed into a non-planar shape was obtained.

### (Production of Optical Laminate A1K21)

An optical laminate A1K21 was obtained as Comparative Example 1 in the same manner as in the production of the optical laminate A1K1 of Example 1, except that the absorptive polarizer film 2K1 was changed to the absorptive polarizer film 2K21.

### <Evaluation of Formed Absorptive Polarizer Film (Axis Variation)>

Variation (half-width of the axis distribution) of the direction of the absorption axis at each position of the light absorption anisotropic film in the absorptive polarizer film formed into a curved surface of Examples 1 to 7 and Comparative Example 1 was measured using a two-dimensional birefringence evaluation system WPA-200, and evaluated according to the following standard.

The “half-width” described in the following standard means a half-width of the maximum peak having the highest frequency in a histogram related to the direction of the absorption axis, which was created according to the above-described procedure. As described above, the histogram was created with a class width of 0.2°.
A: half-width was less than 2.0°.
B: half-width was 2.0° or more and less than 4.0°.
C: half-width was 4.0° or more.

### <Production of Composite Lens>

The optical laminates formed into a non-planar shape produced in Examples 1 to 7 and Comparative Example 1 were bonded to the convex surface side of the half mirror produced above with a pressure sensitive adhesive to obtain a composite lens.

### <Production of Virtual Reality Display Apparatus>

A virtual reality display apparatus “Huawei VR Glass” manufactured by Huawei Technologies Co., Ltd., which was a virtual reality display apparatus for which a reciprocating optical system was employed, was disassembled, and all composite lenses were taken out. Instead, the composite lens 1 formed by using the optical laminate formed into a non-planar shape, produced in Examples 1 to 7 and Comparative Example 1, was incorporated into the main body, and the composite lens was further installed so that the light absorption anisotropic film side in the composite lens was on the eye side, thereby producing a virtual reality display apparatus. In the produced virtual reality display apparatus, a gray image was displayed on the image display panel, and tint unevenness was visually evaluated in the following three stages. The results are shown in Table 4. A or B is preferable.

### (Evaluation for Tint Unevenness)

A: tint unevenness was slightly visible, but not noticeable.
B: weak tint unevenness was visible, but was within an allowable range.
C: strong tint unevenness was observed.

In the column of “Forming condition” in Table 4, “Method 1” indicates a method of providing a temperature distribution to the light absorption anisotropic film using a cholesteric liquid crystal layer which reflects infrared light with a reflectivity of approximately 50%; and “Method 2” indicates a method of providing a temperature distribution to the light absorption anisotropic film by adjusting the pressurization speed.

In Table 4, the column of “Curvature radius” indicates the curvature radius of the light absorption anisotropic film having a curved surface shape.

In Table 4, “A1” in the column of “Constitution” indicates that the laminate included light absorption anisotropic film/positive A-plate/positive C-plate/cholesteric liquid crystal layer, and “B1” indicates that the laminate included light absorption anisotropic film/linear polarization-type reflective polarizer/positive A-plate/positive C-plate.

TABLE 4

| | Light absorption anisotropic film | | | | Evaluation |
|---|---|---|---|---|---|
| | Forming | Curvature | Axis | Consti- | Tint |
| | condition | radius | variation | tution | unevenness |
| Example 1 | Method 1 | 36 mm | A | A1 | A |
| Example 2 | Method 2 | 36 mm | B | A1 | B |
| Example 3 | Method 1 | 36 mm | A | A1 | A |
| Example 4 | Method 1 | 52 mm | A | A1 | A |
| Example 5 | Method 1 | 78 mm | A | A1 | A |
| Example 6 | Method 1 | 64 mm | A | B1 | A |
| Example 7 | Method 1 | 75 mm | A | B1 | A |
| Comparative | — | 36 mm | C | A1 | C |
| Example 1 | | | | | |

As shown in Table 4, it was found that the light absorption anisotropic film according to the embodiment of the present invention exhibited a desired effect.

### Example 8

### (Production of Optical Laminate A1K8 and Composite Lens)

The positive A-plate side of the optical laminate A0 obtained above and the protective layer side of the absorptive polarizer film 1 were bonded to each other with a pressure sensitive adhesive, and only the support of the absorptive polarizer film 1 was peeled off. However, the positive A-plate and the light absorption anisotropic film in the absorptive polarizer film 1 were laminated such that a slow axis of the positive A-plate and an absorption axis of the light absorption anisotropic film 1 formed an angle of 45°. Next, a pressure sensitive adhesive layer was provided on the reflective circular polarizer side using a pressure sensitive adhesive sheet. In this manner, an optical laminate C1 consisting of pressure sensitive adhesive layer/reflective circular polarizer/pressure sensitive adhesive layer/PMMA film/pressure sensitive adhesive layer/positive C-plate/pressure sensitive adhesive layer/positive A-plate/pressure sensitive adhesive layer/absorptive polarizer was obtained.

Next, the optical laminate C1 was set in a forming device. In this case, the absorptive polarizer was disposed to be on the upper side. The forming surface in the forming device consisted of a box 1 and a box 2 partitioned by the optical laminate C1, and a meniscus lens (diameter: 50 mm, curvature radius of concave side: 75 mm) on which aluminum was vapor-deposited on the convex side as the mold was disposed in the box 1 located below the optical laminate C1 such that the concave surface was on the upper side. In addition, a transparent window was installed on the upper part of the box 2 on the upper side of the optical laminate C1, and an IR light source for heating the optical laminate C1 was installed on the outside of the forming device. Between the IR light source and the optical laminate C1, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the center portion of the optical laminate C1 reached 108° C. and the end portion thereof reached 99° C. Next, as a step of pressing the optical laminate C1 against the mold to deform the optical laminate C1 along a shape of the mold, gas was allowed to flow into the box 2 from a gas cylinder to pressurize the optical laminate C1 to 300 kPa, and the optical laminate C1 was pressed against the mold. In this manner, a composite lens including an optical laminate A1K8 formed into a curved surface was obtained as Example 8.

### Example 9

### (Production of Optical Laminate A1K9 and Composite Lens)

The optical laminate C1 was obtained in the same manner as in Example 8. Next, the optical laminate C1 was set in a forming device. In this case, the absorptive polarizer was disposed to be on the upper side. The forming surface in the forming device consisted of a box 1 and a box 2 partitioned by the optical laminate C1, and a meniscus lens (diameter: 50 mm, curvature radius of concave side: 50 mm) on which aluminum was vapor-deposited on the convex side as the mold was disposed in the box 1 located below the optical laminate C1 such that the concave surface was on the upper side. In addition, a transparent window was installed on the upper part of the box 2 on the upper side of the optical laminate C1, and an IR light source for heating the optical laminate C1 was installed on the outside of the forming device. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the center portion of the optical laminate C1 reached 108° C. Next, as a step of pressing the optical laminate C1 against the mold to deform the optical laminate C1 along a shape of the mold, gas was allowed to flow into the box 2 from a gas cylinder to pressurize the optical laminate C1 to 300 kPa, and the optical laminate C1 was pressed against the mold. At this time, the pressurization speed until reaching 300 kPa was adjusted such that the temperature of the end portion in the mold immediately after the compression was set to 99° C. In this manner, a composite lens including an optical laminate A1K9 formed into a curved surface was obtained as Example 9.

### Example 10

### (Production of Optical Laminate A1K10 and Composite Lens)

The optical laminate C1 was obtained in the same manner as in Example 8. Next, the optical laminate C1 was set in a forming device. In this case, the absorptive polarizer was disposed to be on the upper side. The forming surface in the forming device consisted of a box 1 and a box 2 partitioned by the optical laminate C1, and a meniscus lens (diameter: 40 mm, curvature radius of concave side: 40 mm) on which aluminum was vapor-deposited on the convex side as the mold was disposed in the box 1 located below the optical laminate C1 such that the concave surface was on the upper side. In addition, a transparent window was installed on the upper part of the box 2 on the upper side of the optical laminate C1, and an IR light source for heating the optical laminate C1 was installed on the outside of the forming device. Between the IR light source and the optical laminate C1, a cholesteric liquid crystal layer which reflects infrared rays with wavelengths from 2.2 μm to 3.0 μm at a reflectivity of approximately 50% was cut to match the outer peripheral shape of the mold, and the center portion was cut out in a circular shape with a diameter of 1 inch to obtain a ring-shaped patterned infrared reflecting filter. In this case, the center portion of the patterned infrared reflecting filter was disposed to be located at the center portion of the mold in a case of being viewed from directly above. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the center portion of the optical laminate C1 reached 108° C. and the end portion thereof reached 99° C. Next, as a step of pressing the optical laminate C1 against the mold to deform the optical laminate C1 along a shape of the mold, gas was allowed to flow into the box 2 from a gas cylinder to pressurize the optical laminate C1 to 300 kPa, and the optical laminate C1 was pressed against the mold. In this manner, a composite lens including an optical laminate A1K10 formed into a curved surface was obtained as Example 10.

### Example 11

### (Production of Optical Laminate A1K11 and Composite Lens)

An optical laminate C2 consisting of pressure sensitive adhesive layer/reflective circular polarizer/UV adhesive layer/PMMA film/UV adhesive layer/positive C-plate/UV adhesive layer/positive A-plate/UV adhesive layer/absorptive polarizer was obtained in the same manner as the production of the optical laminate A1K10 of Example 10, except that a part was changed to a UV adhesive. Next, in the same manner as in Example 10, an optical laminate C2 was formed into a curved surface instead of the optical laminate C1, and a composite lens including an optical laminate A1K11 formed into a curved surface was obtained as Example 11.

### Example 12

### (Production of Optical Laminate B1K12 and Composite Lens)

The APF side of the optical laminate B0 obtained above and the protective layer side of the absorptive polarizer film 1 were bonded to each other with a pressure sensitive adhesive, and only the support of the absorptive polarizer film 1 was peeled off. However, the APF and the light absorption anisotropic film were laminated such that the transmission axis of the APF and the transmission axis of the light absorption anisotropic film matched each other. Next, a pressure sensitive adhesive layer was provided on the positive C-plate side using a pressure sensitive adhesive sheet. In this manner, an optical laminate D1 consisting of pressure sensitive adhesive layer/positive C-plate/positive A-plate/pressure sensitive adhesive layer/linear polarization-type reflective polarizer/pressure sensitive adhesive layer/absorptive polarizer was obtained.

Next, in the same manner as in Example 8, an optical laminate D1 was formed into a curved surface instead of the optical laminate C1, and a composite lens including an optical laminate B1K12 formed into a curved surface was obtained as Example 12.

### Example 13

### (Production of Optical Laminate B2K13 and Composite Lens)

The retardation layer film 3 on the positive A-plate side was bonded to the absorptive polarizer side of the optical laminate D1 obtained in Example 12 with a pressure sensitive adhesive, and only the support of the retardation layer film 3 was peeled off. However, the positive A-plate and the light absorption anisotropic film were laminated such that a slow axis of the positive A-plate and an absorption axis of the light absorption anisotropic film formed an angle of 45°. Furthermore, the PMMA film side of the moss-eye film 1 was bonded to the peeling surface with a pressure sensitive adhesive. In this manner, an optical laminate D2 consisting of pressure sensitive adhesive layer/positive C-plate/positive A-plate/pressure sensitive adhesive layer/linear polarization-type reflective polarizer/pressure sensitive adhesive layer/absorptive polarizer/pressure sensitive adhesive layer/positive A-plate/positive C-plate/pressure sensitive adhesive layer/PMMA film/UV adhesive layer/moss-eye layer was obtained.

Next, in the same manner as in Example 12, an optical laminate D2 was formed into a curved surface instead of the optical laminate D1, and a composite lens including an optical laminate B2K13 formed into a curved surface was obtained as Example 13.

### Example 14

### (Production of Optical Laminate A1K14 and Composite Lens)

The optical laminate C1 was obtained in the same manner as in Example 10. Next, the optical laminate C1 was formed into a curved surface by changing the curvature radius of the mold from 40 mm to 37 mm with respect to Example 10, and a composite lens including an optical laminate A1K14 formed into a curved surface was obtained as Example 14.

### Example 15

### (Production of Optical Laminate A1K15 and Composite Lens)

A second optically anisotropic layer of the above-described retardation layer film 3 was formed on the yellow light reflecting layer (fifth layer) of the above-described reflective circular polarizer film 1, and a first optically anisotropic layer was further formed.

A photo-alignment film B1, a light absorption anisotropic film C1, and a protective layer D1 of the above-described absorptive polarizer film 1 were formed thereon in this order. However, the photo alignment was performed such that an angle between a slow axis of the first optically anisotropic layer and an absorption axis of the light absorption anisotropic film C1 was 450.

Next, the protective layer D1 side was bonded to a PMMA film through a pressure sensitive adhesive, and the temporary support of the reflective circular polarizer film 1 was peeled off. Next, a pressure sensitive adhesive layer was provided on the reflective circular polarizer side using a pressure sensitive adhesive sheet.

In this manner, an optical laminate E1 consisting of pressure sensitive adhesive layer/reflective circular polarizer/positive C-plate/positive A-plate/absorptive polarizer/pressure sensitive adhesive layer/PMMA film was obtained.

Next, in the same manner as in Example 10, an optical laminate E1 was formed into a curved surface instead of the optical laminate C1, and a composite lens including an optical laminate A1K15 formed into a curved surface was obtained as Example 15.

### Example 16

### (Production of Optical Laminate B1K16 and Composite Lens)

The absorptive polarizer film 1 was replaced with the absorptive polarizer film 3 with the rest being the same as in Example 12. In this manner, an optical laminate D3 consisting of pressure sensitive adhesive layer/positive C-plate/positive A-plate/pressure sensitive adhesive layer/linear polarization-type reflective polarizer/pressure sensitive adhesive layer/absorptive polarizer was obtained.

Next, in the same manner as in Example 8, an optical laminate D3 was formed into a curved surface instead of the optical laminate C1, and a composite lens including an optical laminate B1K16 formed into a curved surface was obtained as Example 16.

### Example 17

### (Production of Optical Laminate A1K17 and Composite Lens)

The absorptive polarizer film 1 was replaced with the absorptive polarizer film 3 with the rest being the same as in Example 8. In this manner, an optical laminate C3 consisting of pressure sensitive adhesive layer/reflective circular polarizer/pressure sensitive adhesive layer/PMMA film/pressure sensitive adhesive layer/positive C-plate/pressure sensitive adhesive layer/positive A-plate/pressure sensitive adhesive layer/absorptive polarizer was obtained.

Next, in the same manner as in Example 8, an optical laminate C3 was formed into a curved surface instead of the optical laminate C1, and a composite lens including an optical laminate A1K17 formed into a curved surface was obtained as Example 17.

### Example 18

### (Production of Optical Laminate A2K18)

A second optically anisotropic layer of the above-described retardation layer film 3 was formed on the yellow light reflecting layer (fifth layer) of the above-described reflective circular polarizer film 1, and a first optically anisotropic layer was further formed. A photo-alignment film B1 and a light absorption anisotropic film C1 of the above-described absorptive polarizer film 1 were formed thereon in this order. However, the photo alignment was performed such that an angle between a slow axis of the first optically anisotropic layer and an absorption axis of the light absorption anisotropic film C1 was 45°.

An optically anisotropic layer described in paragraphs [0172] to [0184] of WO2022/054556A was formed on the light absorption anisotropic film C1. The optically anisotropic layer is a QWP layer having a twist alignment function of converting linearly polarized light into circularly polarized light.

Furthermore, the protective layer D1 of the absorptive polarizer film 1 was formed thereon.

Next, the protective layer D1 side was bonded to the PMMA film side of the moth-eye film through an UV adhesive, and the temporary support of the reflective circular polarizer film 1 was peeled off. Next, a pressure sensitive adhesive layer was provided on the reflective circular polarizer side using a pressure sensitive adhesive sheet.

In this manner, an optical laminate E2 consisting of pressure sensitive adhesive layer/reflective circular polarizer/positive C-plate/positive A-plate/absorptive polarizer/QWP layer/protective layer/UV adhesive layer/PMMA film/moss-eye layer was obtained.

Next, in the same manner as in Example 10, an optical laminate E2 was formed into a curved surface instead of the optical laminate C1, and a composite lens including an optical laminate A2K18 formed into a curved surface was obtained as Example 18.

### Example 19

### (Production of Optical Laminate B1K19 and Composite Lens)

An optical laminate D4 was obtained according to the same procedure as in Example 12, except that the absorptive polarizer film 1 was replaced with the absorptive polarizer film 4. The configuration of the optical laminate D4 was pressure sensitive adhesive layer/positive C-plate/positive A-plate/pressure sensitive adhesive layer/linear polarization-type reflective polarizer/pressure sensitive adhesive layer/absorptive polarizer/acrylic film.

Next, in the same manner as in Example 12, the curved surface of the optical laminate D4 was formed instead of the optical laminate D1. Thereafter, the obtained laminate was put into a chamber set at 65° C. and 95% RH for 2 hours, thereby obtaining, as Example 19, a composite lens including an optical laminate B1K19 formed into a curved surface.

### Example 20

### (Production of Optical Laminate A1K20 and Composite Lens)

An optical laminate C4 was obtained according to the same procedure as in Example 8, except that the absorptive polarizer film 1 was replaced with the absorptive polarizer film 4. A configuration of the optical laminate C4 was pressure sensitive adhesive layer/reflective circular polarizer/pressure sensitive adhesive layer/PMMA film/pressure sensitive adhesive layer/positive C-plate/pressure sensitive adhesive layer/positive A-plate/pressure sensitive adhesive layer/absorptive polarizer/acrylic film.

Next, in the same manner as in Example 8, the curved surface of the optical laminate C4 was formed instead of the optical laminate C1. Thereafter, the obtained laminate was put into a chamber set at 65° C. and 95% RH for 2 hours, thereby obtaining, as Example 20, a composite lens including an optical laminate A1K20 formed into a curved surface.

### Comparative Example 2

### (Production of Optical Laminate A1K22)

The optical laminate C1 was obtained in the same manner as in Example 8. Next, the optical laminate C1 was set in a forming device. In this case, the absorptive polarizer was disposed to be on the upper side. The forming surface in the forming device consisted of a box 1 and a box 2 partitioned by the optical laminate C1, and a meniscus lens (diameter: 40 mm, curvature radius of concave side: 40 mm) on which aluminum was vapor-deposited on the concave side as the mold 2 was disposed in the box 1 located below the optical laminate C1 such that the concave surface was on the upper side. In addition, a transparent window was installed on the upper part of the box 2 on the upper side of the optical laminate C1, and an IR light source for heating the optical laminate C1 was installed on the outside of the forming device. Next, each of the inside of the box 1 and the inside of the box 2 was evacuated to 0.1 atm or less by a vacuum pump. Next, as a step of heating the optical laminate C1, the optical laminate C1 was irradiated with infrared rays and heated until the temperature of the optical laminate C1 reached 108° C. Next, as a step of pressing the optical laminate C1 against the mold to deform the optical laminate C1 along a shape of the mold, gas was allowed to flow into the box 2 from a gas cylinder to pressurize the optical laminate C1 to 300 kPa, and the optical laminate C1 was pressed against the mold. In this manner, a composite lens including an optical laminate A1K22 formed in a non-planar shape was obtained as Comparative Example 2.

### <Evaluation of Formed Absorptive Polarizer Film>

In the same manner as in Example 1, the variation (half-width of the axis distribution) of the direction of the absorption axis of the light absorption anisotropic film formed into a curved surface was evaluated for Examples 8 to 17 and Comparative Example 2, and the results are shown in Table 5.

### <Production of Virtual Reality Display Apparatus>

The composite lenses having the optical laminates produced in Examples 8 to 17, 19, and 20 and Comparative Example 2 were evaluated in the same manner as in Example 1, and the results are shown in Table 5.

In the column of “Forming condition” in Table 5, “Method 1” indicates a method of providing a temperature distribution to the light absorption anisotropic film using a cholesteric liquid crystal layer which reflects infrared light with a reflectivity of approximately 50%; and “Method 2” indicates a method of providing a temperature distribution to the light absorption anisotropic film by adjusting the pressurization speed.

In Table 5, the column of “Curvature radius” indicates the curvature radius of the light absorption anisotropic film having a curved surface shape.

In the column of “Configuration” in Table 5, “A1” indicates that the laminate included light absorption anisotropic film/positive A-plate/positive C-plate/cholesteric liquid crystal layer; “B1” indicates that the laminate included light absorption anisotropic film/linear polarization-type reflective polarizer/positive A-plate/positive C-plate; “B2” indicates that the laminate included moss-eye layer/positive A-plate/light absorption anisotropic film/linear polarization-type reflective polarizer/positive A-plate/positive C-plate; and “A2” indicates that the laminate included moss-eye layer/QWP layer/light absorption anisotropic film/positive A-plate/positive C-plate/cholesteric liquid crystal layer.

TABLE 5

| | Laminate | | | | Evaluation |
|---|---|---|---|---|---|
| | Forming | Curvature | Axis | Consti- | Tint |
| | condition | radius | variation | tution | unevenness |
| Example 8 | Method 1 | 75 mm | A | A1 | A |
| Example 9 | Method 2 | 50 mm | B | A1 | B |
| Example 10 | Method 1 | 40 mm | A | A1 | A |
| Example 11 | Method 1 | 40 mm | A | A1 | A |
| Example 12 | Method 1 | 75 mm | A | B1 | A |
| Example 13 | Method 1 | 75 mm | A | B2 | A |
| Example 14 | Method 1 | 37 mm | A | A1 | A |
| Example 15 | Method 1 | 40 mm | A | A1 | A |
| Example 16 | Method 1 | 75 mm | A | B1 | A |
| Example 17 | Method 1 | 75 mm | A | A1 | A |
| Example 19 | Method 1 | 75 mm | A | B1 | A |
| Example 20 | Method 1 | 75 mm | A | A1 | A |
| Comparative | — | 40 mm | C | A1 | C |
| Example 2 | | | | | |

As shown in Table 5, it was found that the light absorption anisotropic film according to the embodiment of the present invention exhibited a desired effect.

Although not shown in the above table, the same results as those in other examples were obtained even in Example 18.

### Examples 21 to 35

In Examples 1 to 15, it was confirmed that the effect of the present invention was exhibited by producing composite lenses of Examples 21 to 35 by changing the surfactant F-3 contained in the composition C1 for forming a light absorption anisotropic film of the absorptive polarizer to the following surfactant F-4, changing the glutaraldehyde contained in the coating liquid D1 for forming a protective layer of the absorptive polarizer to 2,5-dimethoxytetrahydrofuran, and changing the surfactant F-9 to BYK-348 (manufactured by BYK-Chemie GmbH; silicon-based surfactant).

### Surfactant F-4 (Weight-Average Molecular Weight: 15,000)

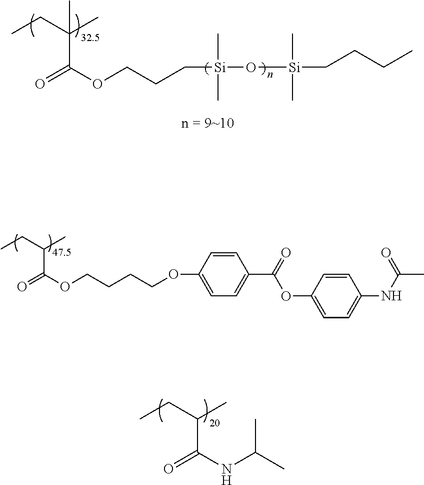

### <Preparation of Polyvinyl Alcohol Adhesive 1>

A polyvinyl alcohol adhesive 1 was prepared according to the following procedure.

20 parts by mass of methylol melamine with respect to 100 parts by mass of a polyvinyl alcohol-based resin having an acetoacetyl group (average degree of polymerization: 1200, degree of saponification: 98.5% by mole, degree of acetoacetylation: 5% by mole) was dissolved in pure water under a temperature condition of 30° C. to prepare an aqueous solution in which the concentration of solid contents was adjusted to 3.7% by mass.

### Examples 36 to 39

An absorptive polarizer film 10 was produced by not forming the protective layer D1 in the production of the absorptive polarizer film 1.

The positive A-plate side of the optical laminate A0 obtained above and the light absorption anisotropic film side of the absorptive polarizer film 10 were bonded to each other with the polyvinyl alcohol adhesive 1, and only the support of the absorptive polarizer film 10 was peeled off to obtain an optical laminate. However, the positive A-plate and the light absorption anisotropic film in the absorptive polarizer film 10 were laminated such that a slow axis of the positive A-plate and an absorption axis of the light absorption anisotropic film 10 formed an angle of 45°. A film thickness of the formed polyvinyl alcohol adhesive layer was 1 μm, and an oxygen permeability coefficient thereof was 200 cc/m²·day·atm or less. Next, composite lenses of Examples 36 to 39 were produced by the same procedure as in Examples 8, 9, 10, and 14 using the obtained optical laminates, and it was confirmed that the effect of the present invention was exhibited.

### Example 40

An absorptive polarizer film 30 was produced by not forming the protective layer D1 in the production of the absorptive polarizer film 3.

The positive A-plate side of the optical laminate A0 obtained above and the light absorption anisotropic film side of the absorptive polarizer film 30 were bonded to each other with the polyvinyl alcohol adhesive 1, and only the support of the absorptive polarizer film 30 was peeled off to obtain an optical laminate. However, the positive A-plate and the light absorption anisotropic film in the absorptive polarizer film 30 were laminated such that a slow axis of the positive A-plate and an absorption axis of the light absorption anisotropic film 30 formed an angle of 45°. A film thickness of the formed polyvinyl alcohol adhesive layer was 1 μm, and an oxygen permeability coefficient thereof was 200 cc/m²·day·atm or less.

Next, a composite lens of Example 40 was produced by the same procedure as in Example 17 using the obtained optical laminate, and it was confirmed that the effect of the present invention was exhibited.

### EXPLANATION OF REFERENCES

10, 52: light absorption anisotropic film
12: center
14: first surface
16: second surface
20, 40: forming die having concave forming surface
22: film
24: film on which concave surface shape is transferred
42: planar light absorption anisotropic film
50A, 50B: laminate
54: retardation layer having function of converting linearly polarized light into circularly polarized light
56: positive C-plate
58: cholesteric liquid crystal layer
60: linear polarization-type reflective polarizer
70: composite lens
72, 90: laminate
74, 88: lens
76, 86: half mirror
80: virtual reality display apparatus
82: image display panel
84: circularly polarizing plate
92: ray

What is claimed is:

1. A light absorption anisotropic film comprising:
a dichroic substance,
wherein the light absorption anisotropic film has a non-planar shape portion, and
in a case where a direction of an absorption axis at each position of the non-planar shape portion is measured and a histogram related to the direction of the absorption axis is created, a half-width of a maximum peak having a highest frequency in the histogram is less than 4.0°.

2. The light absorption anisotropic film according to claim 1, further comprising:
a liquid crystal compound.

3. The light absorption anisotropic film according to claim 1,
wherein the half-width is 2.0° or less.

4. The light absorption anisotropic film according to claim 1,
wherein the non-planar shape portion has a curved surface shape, and
a curvature radius of the non-planar shape portion is 20 to 80 mm.

5. The light absorption anisotropic film according to claim 1,
wherein the film thickness of the non-planar shape portion is 8.0 μm or less.

6. A laminate comprising:
the light absorption anisotropic film according to claim 1.

7. The laminate according to claim 6,
wherein the laminate includes the light absorption anisotropic film, a retardation layer, and a cholesteric liquid crystal layer in this order.

8. The laminate according to claim 6,
wherein the laminate includes the light absorption anisotropic film, a linear polarization-type reflective polarizer, and a retardation layer in this order.

9. The laminate according to claim 6, further comprising:
a surface antireflection layer.

10. The laminate according to claim 6,
wherein the laminate includes two or more retardation layers, and
the retardation layer has a function of converting linearly polarized light into circularly polarized light.

11. The laminate according to claim 6,
wherein the laminate does not include a pressure-sensitive adhesive layer.

12. The laminate according to claim 6, further comprising:
one or two pressure-sensitive adhesive layers.

13. The laminate according to claim 6,
wherein, in a case where the laminate does not include both a pressure-sensitive adhesive layer and a support, a thickness of the laminate is 30 μm or less,
in a case where the laminate includes one of the pressure-sensitive adhesive layer or the support but does not include the other, a value obtained by subtracting a thickness of the one from the thickness of the laminate is 30 μm or less, and
in a case where the laminate includes both the pressure-sensitive adhesive layer and the support, a value obtained by subtracting a thickness of the pressure-sensitive adhesive layer and a thickness of the support from the thickness of the laminate is 30 μm or less.

14. A composite lens comprising, in the following order:
the laminate according to claim 7;
a lens; and
a half mirror.

15. A virtual reality display apparatus comprising:
the laminate according to claim 6.

16. The light absorption anisotropic film according to claim 2,
wherein the half-width is 2.0° or less.

17. The light absorption anisotropic film according to claim 2,
wherein the non-planar shape portion has a curved surface shape, and
a curvature radius of the non-planar shape portion is 20 to 80 mm.

18. The light absorption anisotropic film according to claim 2,
wherein the film thickness of the non-planar shape portion is 8.0 μm or less.

19. A laminate comprising:
the light absorption anisotropic film according to claim 2.

20. The laminate according to claim 19,
wherein the laminate includes the light absorption anisotropic film, a retardation layer, and a cholesteric liquid crystal layer in this order.
